(19) United States
(12) Patent Application Publication
(10) Pub. No.: US 2016/0289945 A1
(43) Pub. Date: Oct. 6, 2016

(54) COMBINATION TOILET AND URINAL

(71) Applicant: Robert W. Seneff, Waukesha, WI (US)

(72) Inventor: Robert W. Seneff, Waukesha, WI (US)

(21) Appl. No.: 15/176,026

(22) Filed: Jun. 7, 2016

Related U.S. Application Data
(63) Continuation of application No. 15/162,455, filed on May 23, 2016, now abandoned.
(60) Provisional application No. 62/309,545, filed on Mar. 17, 2016.

(51) Int. Cl. E03D 13/00; E03D 9/00; A47K 13/08; F16K 5/06; A47K 13/00; E03D 11/02; E03C 1/284

(52) U.S. Cl. CPC E03D 13/007; E03D 11/025; E03D 9/005; E03C 1/284; F16K 5/06; A47K 13/00; A47K 13/08; E03D 2201/00

(57) ABSTRACT

In one aspect, a device including urinal and toilet capabilities is provided. The device includes a toilet bowl, a toilet seat coupled to and rotatable relative to the toilet bowl, and a toilet cover coupled to and rotatable relative to the toilet bowl. The toilet cover includes a receptacle configured to receive urine. In one aspect, an overflow assembly for a toilet is provided and includes a sensor configured to sense a water level in a toilet bowl, a first communication device in electrical communication with the sensor, and a second communication device in communication with the first communication device. The first communication device is configured to transmit data to the second communication device associated with the water level in the toilet bowl.

### RELATED APPLICATIONS

The present application is a continuation of co-pending U.S. Non-Provisional patent application Ser. No. 15/162,455, filed May 23, 2016, which claims the priority benefit of co-pending U.S. Provisional Patent Application No. 62/309,545, filed Mar. 17, 2016, all of which are incorporated by reference herein in their entirety.

### FIELD OF THE INVENTION

The present disclosure generally relates to restroom devices used for defecation and urination and, more particularly, to combination devices used for both defecation and urination.

### BACKGROUND

Many public and private restrooms solely include one or more toilets. IN other situations, a toilet may be the only device available in the restroom if urinals are already occupied. Toilets are flushed in the same manner no matter the manner in which the user uses the toilets. Thus, if a user solely urinates in the toilets, a large quantity of water is used when the toilet is flushed even though a large quantity of water is not required. Additionally, some users prefer to use a urinal over a toilet, but toilets may be the only available fixture. Urination in a toilet may result in splash or other undesirable results.

Furthermore, toilets often overflow due to a blocked or clogged drain, which can result in a mess and/or water damage.

### SUMMARY

Thus, a need exists for a device, apparatus, method or assembly that cures these and other deficiencies.

In one example, a device including urinal and toilet capabilities is provided and includes a toilet bowl, a toilet seat coupled to and rotatable relative to the toilet bowl, and a toilet cover coupled to and rotatable relative to the toilet bowl. The toilet cover includes a receptacle configured to receive urine.

In one aspect, a toilet cover configured to couple to and be rotatable relative to a toilet bowl is provided. The toilet cover includes a first member, a second member rotatable relative to the first member, and a receptacle between the first member and the second member. The receptacle is configured to receive urine and is configured to be in fluid communication with a drain.

In one aspect, a device including urinal and toilet capabilities is provided and includes a toilet bowl, a toilet seat coupled to and rotatable relative to the toilet bowl, and a toilet cover coupled to and rotatable relative to the toilet bowl. The toilet cover includes a receptacle configured to receive urine. The device also includes a first drain in fluid communication with the toilet bowl and a second drain in fluid communication with the receptacle.

In one aspect, the device further includes a valve in fluid communication with the second drain.

In one aspect, the valve is a ball valve.

In one aspect, an overflow assembly for a toilet is provided and includes a sensor configured to generate data associated with an overflow condition and a first communication device in electrical communication with the sensor to receive the data. The first communication device is configured to transmit the data. The overflow assembly also includes a second communication device configured to receive the data transmitted by the first communication device.

In one aspect, the first communication device is configured to transmit the data over a network, and the second communication device is configured to receive the data over the network.

In one aspect, a device including urinal and toilet capabilities is provided and includes a toilet bowl, a toilet seat coupled to and rotatable relative to the toilet bowl, and a toilet cover coupled to and rotatable relative to the toilet bowl. The toilet cover includes a receptacle configured to receive urine.

In one aspect, the toilet cover may include a first member and a second member rotatable relative to the first member. The receptacle may be positioned between the first member and the second member, and the receptacle may be configured to be in fluid communication with a drain.

In one aspect, the receptacle may have a closed position, in which the first member and the second member are proximate each other, and an opened position, in which the second member is rotated away from the first member.

In one aspect, the second member may include a resilient wall at least partially defining the receptacle and may be at least partially resiliently biased away from the second member due to its resiliency. The resilient wall may be biased toward the second member in the closed position and may move away from the second member in the opened position.

In one aspect, the device may further include an engagement member configured to engage the first member and inhibit downward rotation of the first member toward the toilet bowl with the receptacle in the opened position.

In one aspect, the engagement member may not inhibit downward rotation of the first member toward the toilet bowl with the receptacle in the closed position.

In one aspect, the device may further include an engagement member configured to engage the first member and the second member. The second member may be configured to move the engagement member between a locked condition, in which the engagement member inhibits the first member from moving and may allow the second member to move relative to the first member to present the receptacle in the opened position, and an unlocked condition, in which the second member may be rotated proximate the first member, the receptacle may be in the closed position and the first and second members may be configured to rotate together toward the toilet bowl.

In one aspect, the engagement member may be resilient and may be resiliently biased toward the locked condition.

In one aspect, the receptacle may be in fluid communication with a first drain and the toilet bowl may be in fluid communication with a second drain separate from the first drain.

In one aspect, the first drain may include a first trap and the second drain may include a second trap.

In one aspect, the device may further include a nozzle configured to spray liquid into the receptacle.

In one aspect, the nozzle may be in fluid communication with a water supply and may be configured to spray water into the receptacle.

In one aspect, the nozzle may be in fluid communication with a source of sanitizing solution and may be configured to spray sanitizing solution into the receptacle.

In one aspect, the nozzle may also be in fluid communication with a water supply, and the nozzle may be configured to selectively spray at least one of water and sanitizing solution into the receptacle.

In one aspect, the device may further include an overflow sensor configured to sense an overflow condition in the toilet bowl.

In one aspect, a toilet cover configured to couple to and be rotatable relative to a toilet bowl is provided. The toilet cover includes a first member, a second member rotatable relative to the first member, and a receptacle between the first member and the second member. The receptacle is configured to receive urine.

In one aspect, the receptacle may have a closed position, in which the first member and the second member are proximate each other, and an opened position, in which the second member is rotated away from the first member.

In one aspect, the second member may include a resilient wall at least partially defining the receptacle and may be at least partially resiliently biased away from the second member due to its resiliency. The resilient wall may be biased toward the second member in the closed position and may move away from the second member in the opened position.

In one aspect, the toilet cover may further include an engagement member configured to engage the first member and inhibit downward rotation of the first member with the receptacle in the opened position.

In one aspect, the engagement member may not inhibit downward rotation of the first member toward the toilet bowl with the receptacle in the closed position.

In one aspect, the toilet cover may further include an engagement member configured to engage the first member and the second member. The second member may be configured to move the engagement member between a locked condition, in which the engagement member inhibits the first member from moving and allows the second member to move relative to the first member to present the receptacle in the opened position, and an unlocked condition, in which the second member is rotated proximate the first member, the receptacle is in the closed position and the first and second members are configured to rotate downward together.

In one aspect, the engagement member may be resilient and may be resiliently biased toward the locked condition.

In one aspect, the receptacle may be in fluid communication with a drain.

In one aspect, the receptacle may be configured to be in fluid communication with a toilet bowl.

In one aspect, the toilet cover further includes a urinal drain in fluid communication with the receptacle. The urinal drain may be configured to be in fluid communication with a toilet bowl.

In one aspect, the toilet cover may further include a nozzle configured to spray liquid into the receptacle.

In one aspect, the nozzle may be in fluid communication with a water supply and may be configured to spray water into the receptacle.

In one aspect, the nozzle may be in fluid communication with a source of sanitizing solution and may be configured to spray sanitizing solution into the receptacle.

In one aspect, the nozzle may also be in fluid communication with a water supply, and the nozzle may be configured to selectively spray at least one of water and sanitizing solution into the receptacle.

In one aspect, the toilet cover may further include an overflow sensor configured to sense an overflow condition in the toilet bowl.

In one aspect, a device including urinal and toilet capabilities is provided and includes a toilet bowl, a toilet seat coupled to and rotatable relative to the toilet bowl, and a toilet cover coupled to and rotatable relative to the toilet bowl. The toilet cover includes a receptacle configured to receive urine. The device also includes a first drain in fluid communication with the toilet bowl and a second drain in fluid communication with the receptacle.

In one aspect, the device may further include a valve in fluid communication with the second drain.

In one aspect, the valve may be a ball valve.

In one aspect, the ball valve may be moveable between a first seat and a second seat.

In one aspect, the first seat may be an upper seat and the second seat may be a lower seat, and the ball valve may be selectively moveable between the upper seat and the lower seat.

In one aspect, the ball valve may be at rest against the lower seat and may be configured to float upward away from the lower seat to allow urine to pass thereby through the second drain.

In one aspect, the ball valve may be configured to engage the upper seat to inhibit back pressure through the second drain and into the receptacle.

In one aspect, an overflow assembly for a toilet is provided and includes a sensor configured to sense a water level in a toilet bowl, a first communication device in electrical communication with the sensor, and a second communication device in communication with the first communication device. The first communication device is configured to transmit data to the second communication device associated with the water level in the toilet bowl.

In one aspect, the first communication device may be configured to transmit the data to the second communication device over a network.

In one aspect, the first communication device is configured to wirelessly transmit the data to the second communication device.

In one aspect, upon receipt of the data associated with the water level by the second communication device, the second communication device may be configured to initiate performance of at least one of a visual indicator, an audible noise and transmission of data.

In one aspect, upon receipt of the data associated with the water level by the second communication device, the second communication device may be configured to transmit data to the first communication device.

In one aspect, the first communication device may be configured to initiate performance of shutting off a water supply to the toilet upon receipt of the data from the second communication device.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a top perspective view of one example of a device configured to be used as both a toilet and a urinal with one example of a toilet cover and one example of a toilet seat in respective down positions, according to one aspect of the present disclosure.

FIG. 2 is a top perspective view of the device shown in FIG. 1 with the toilet cover shown in an upward position and the toilet seat shown in a down position, according to one aspect of the present disclosure.

FIG. 3 is a top perspective view of the device shown in FIG. 1 with one example of a panel removed to expose components of the device, according to one aspect of the present disclosure.

FIG. 4 is a top perspective view of the device shown in FIG. 1 with the toilet cover in an opened position to expose one example of a urinal, according to one aspect of the present disclosure.

FIG. 5 is an elevational view of the device shown in FIG. 4, according to one aspect of the present disclosure.

FIG. 6 is an exploded view of a portion of the device shown in FIG. 1 with at least a portion of the toilet cover and the toilet seat exploded, according to one aspect of the present disclosure.

FIG. 7 is an enlarged perspective view of a portion of FIG. 6, according to one aspect of the present disclosure.

FIG. 8 is a top perspective view of a portion of the device shown in FIG. 1, according to one aspect of the present disclosure.

FIG. 9 is a top cross-sectional perspective view of a portion of the toilet cover taken along line 9-9 in FIG. 4, according to one aspect of the present disclosure.

FIG. 10 is a top cross-sectional perspective view of a portion of the device shown in FIG. 1 with one example of a limiting member facilitating positioning of the toilet cover in one example of an opened position, according to one aspect of the present disclosure.

FIG. 11 is an elevational view of the limiting member shown in FIG. 10 and the toilet cover in the exemplary opened position, according to one aspect of the present disclosure.

FIG. 12 is a top-cross sectional perspective view of a portion of the device shown in FIG. 1 with the toilet cover in one example of an intermediate position between the opened position and a closed position, according to one aspect of the present disclosure.

FIG. 13 is an elevational view of the limiting member shown in FIG. 10 and the toilet cover in the exemplary closed position, according to one aspect of the present disclosure.

FIG. 14 is a top cross-sectional perspective view of the device shown in FIG. 1 with exemplary components thereof exposed and the toilet cover and the toilet seat in respective downward positions, according to one aspect of the present disclosure.

FIG. 15 is a top cross-sectional perspective view of the device shown in FIG. 14 with the toilet cover in the upward and opened positions and the toilet seat in its downward position, according to one aspect of the present disclosure.

FIG. 16 is a top cross-sectional perspective view of another example of a device configured to be used as both a toilet and a urinal with another example of a toilet cover, according to one aspect of the present disclosure.

FIG. 17 is a top perspective view of a portion of the device shown in FIG. 1 including one example of two flush capabilities and associated components, according to one aspect of the present disclosure.

FIG. 18 is a top perspective view of another example of a portion of the device shown in FIG. 17 with a single flush capability and associated components, according to one aspect of the present disclosure.

FIG. 19 is a top cross-sectional perspective view of a portion of the device shown in FIG. 1 with one example of a reverse flow stop member in a first position, according to one aspect of the present disclosure.

FIG. 20 is an elevational view of a portion of the device shown in FIG. 1 with the reverse flow stop member of FIG. 19 in the first position, according to one aspect of the present disclosure.

FIG. 21 is an elevational view of a portion of the device shown in FIG. 1 with the reverse flow stop member of FIG. 19 in a second position, according to one aspect of the present disclosure.

FIG. 22 is a top perspective view of a portion of the device shown in FIG. 1 including one example of an overflow assembly, according to one aspect of the present disclosure.

FIG. 23 is a top perspective view of a portion of the device shown in FIG. 1 including another example of an overflow assembly, according to one aspect of the present disclosure.

FIG. 24 is an exemplary schematic diagram of one example of an overflow assembly, according to one aspect of the present disclosure.

FIG. 25 is top perspective view of another example of a device configured to be used as both a toilet and a urinal with another example of a toilet cover in upward and opened positions and one example of a toilet seat in a down position, according to one aspect of the present disclosure.

FIG. 26 is a top cross-sectional perspective view of another example of a drainage system useable with a device configured to be used as both a toilet and a urinal, according to one aspect of the present disclosure.

FIG. 27 is a top cross-sectional perspective view of a further example of a drainage system useable with a device configured to be used as both a toilet and a urinal, according to one aspect of the present disclosure.

FIG. 28 is a top cross-sectional perspective view of still another example of a drainage system useable with a device configured to be used as both a toilet and a urinal, according to one aspect of the present disclosure.

FIG. 29 is a top cross-sectional perspective view of yet another example of a drainage system useable with a device configured to be used as both a toilet and a urinal, according to one aspect of the present disclosure.

FIG. 30 is a top cross-sectional perspective view of one example of a device configured to be coupled to an existing toilet to convert the toilet for use as both a toilet and a urinal, according to one aspect of the present disclosure.

FIG. 31 is an enlarged top cross-sectional perspective view of a portion of FIG. 30, according to one aspect of the present disclosure.

FIG. 32 is an elevational view of a portion of the device and toilet shown in FIG. 30, according to one aspect of the present disclosure.

FIG. 33 is a top cross-sectional perspective view of another example of a device configured to be coupled to an existing toilet to convert the toilet for use as both a toilet and a urinal, according to one aspect of the present disclosure.

FIG. 34 is an enlarged top cross-sectional perspective view of a portion of FIG. 33, according to one aspect of the present disclosure.

FIG. 35 is an elevational view of a portion of the device and toilet shown in FIG. 33, according to one aspect of the present disclosure.

FIG. 36 is an exploded top perspective view of one example of an overflow assembly configured to be used with an existing toilet, according to one aspect of the present disclosure.

FIG. 37 is an exploded top perspective view of another example of an overflow assembly configured to be used with an existing toilet, according to one aspect of the present disclosure.

### DETAILED DESCRIPTION

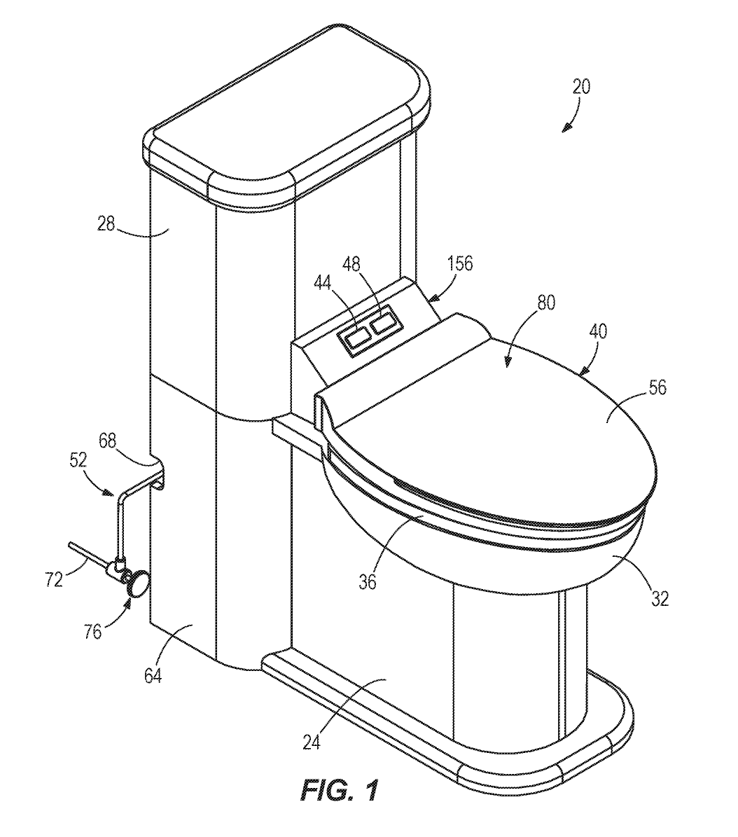

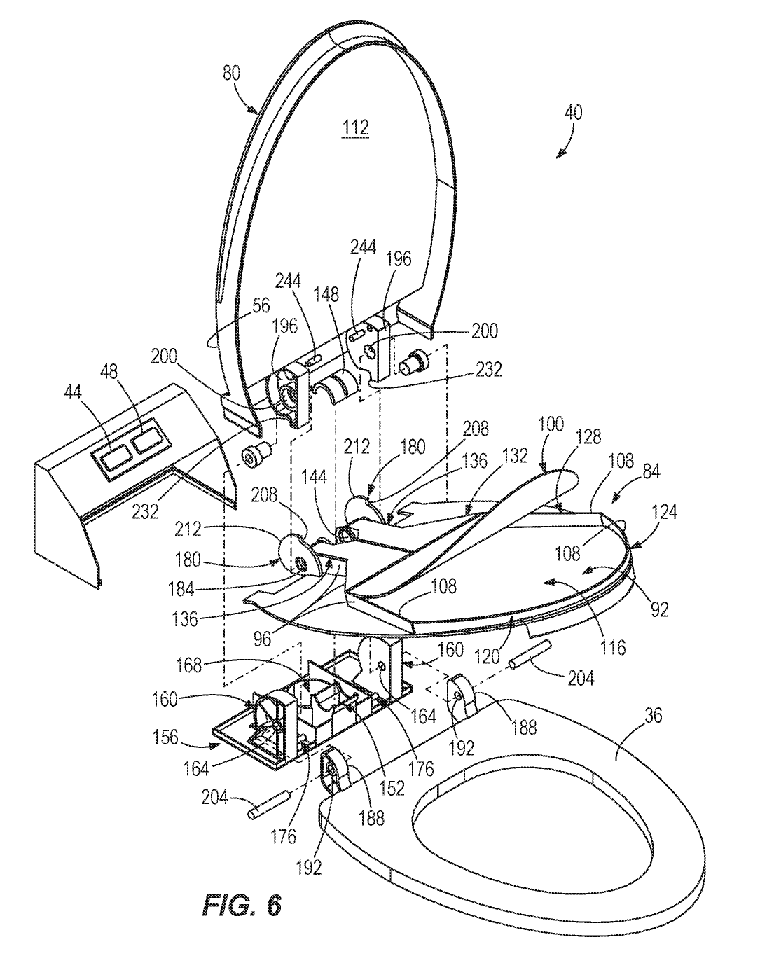

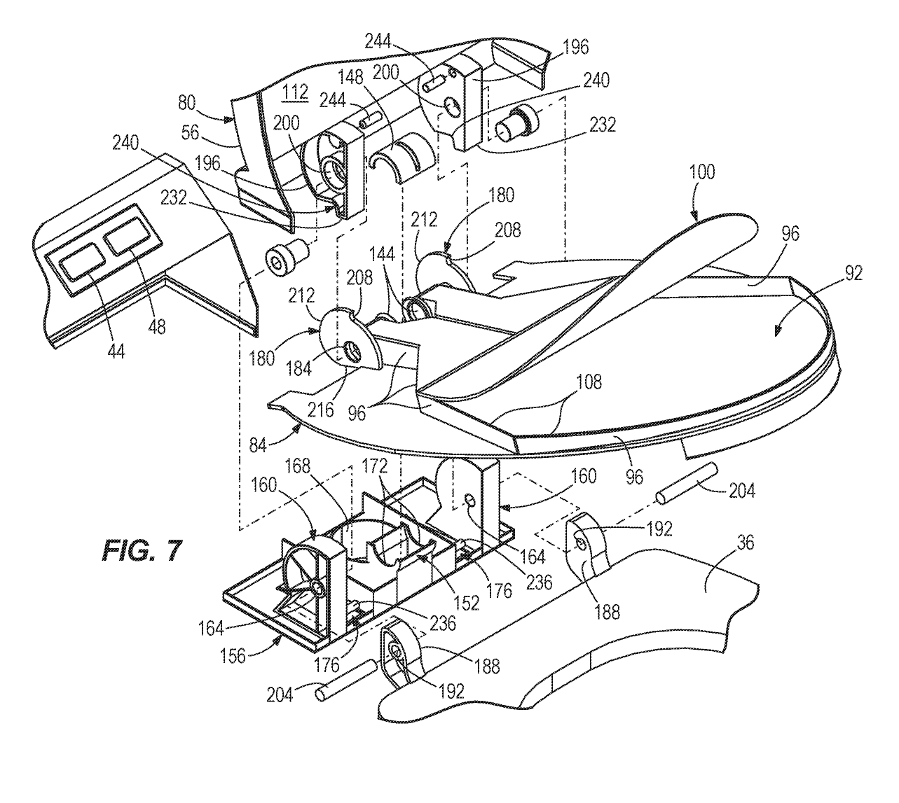

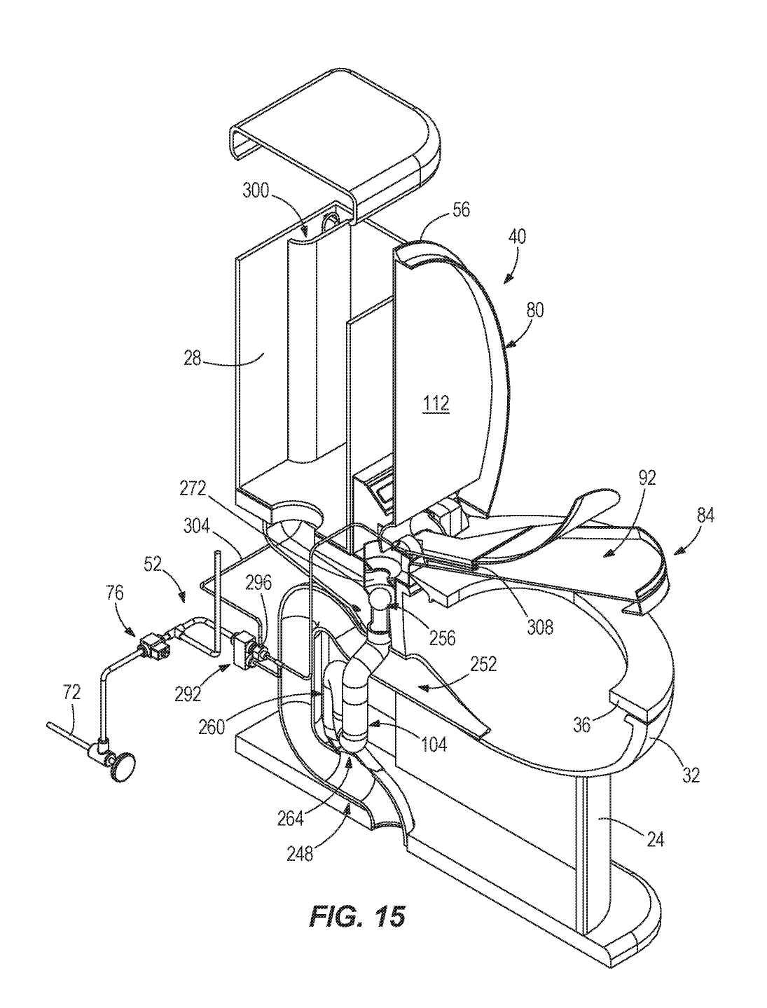

FIGS. 1-24 illustrate one example of a device 20 configured to be used as both a toilet and a urinal. In this illustrated example, the device 20 includes a base 24, a reservoir tank 28, a bowl 32, a seat 36, a cover 40, actuators 44, 48 for controlling operation of the device 20, and associated plumbing 52 (only a portion of the pluming is exposed in FIG. 1). The illustrated examples of these and possibly other components of the device 20 are provided to demonstrate at least some of the principles of the present disclosure and are not intended to be limiting upon the present disclosure. Rather, the device 20 and its components are capable of having a wide variety of shapes, sizes, configurations, functionalities, etc., and all of such possibilities are intended to be within the spirit and scope of the present disclosure. For example, the base 24, the reservoir tank 28, the bowl 32 and the seat 36 may have any shape, size and configuration and still provide the necessary functionality required by the present disclosure. Accordingly, the base 24, the reservoir tank 28, the bowl 32 and the seat 36 will not be discussed in great detail herein.

With particular reference to FIG. 1, the device 20 is shown with the toilet seat 36 in a down position and the toilet cover 40 in a down position. In such positions, the toilet seat 36 engages a top of the toilet bowl 32 and the toilet cover 40 engages a top of the toilet seat 36. As is customary, the toilet seat 36 and the toilet cover 40 are movable relative to the toilet bowl 32.

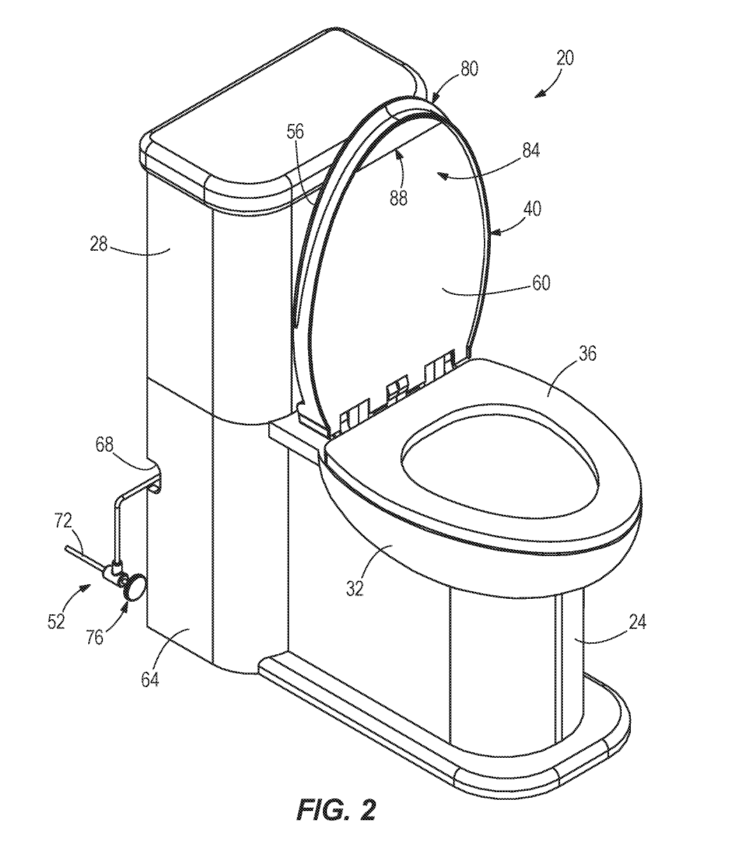

With reference to FIG. 2, the toilet cover 40 has been moved to and is positioned in an upward position, in which the toilet cover 40 is moved away from a top of the toilet seat 36 and the top of the toilet bowl 32. In one example, a top 56 of the toilet cover 40 may engage a portion of the reservoir tank 28. In another example, the toilet cover 40 may be moved to or past a vertical orientation to ensure that the toilet cover 40 is over-center and does not fall or move back toward the toilet seat 36 or the top of the toilet bowl 32. In FIG. 2, the toilet seat 36 remains in the down position. However, the toilet seat 36 may also be moved to an upward position, in which the top of the toilet seat 36 engages a bottom 60 of the toilet cover 40. In this upward position, the toilet seat 36 is at or past a vertical position (i.e., over-center) to inhibit the toilet seat 36 from falling or moving back toward the top of the toilet bowl 32. In the illustrated example, the toilet seat 36 and the toilet cover 40 are rotated between the respective upward and down positions. In other examples, the toilet seat 36 and the toilet cover 40 may be moved between the respective upward and down positions in other manners.

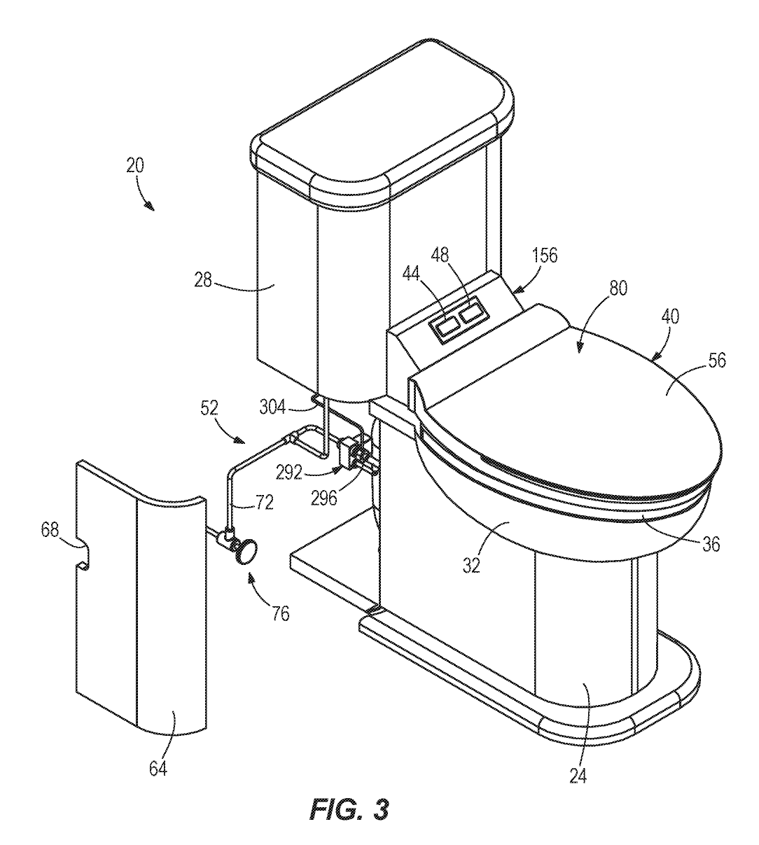

Referring now to FIG. 3, the illustrated example of the device 20 includes a panel or cover 64 that is selectively coupled to and uncoupled from at least one of the base 24 and/or the reservoir tank 28. The panel 64 is configured to selectively cover and allow access to at least a portion of the plumbing 52 used with the device 20. The panel 64 may be selectively coupled to at least one of the base 24 and the reservoir tank 28 in a variety of manners including, but not limited to, fastened, resistance-fit, interference-fit, friction-fit, snap-fit, one or more detents, hook-and-loop type fasteners, latched, or any other type of manner that facilitates selective coupling. In the illustrated example, the panel 64 includes a cutout or recess 68 to allow at least a portion of the plumbing 52 to pass through or pass by the panel 64. In this example, the plumbing 52 passing by or through the panel 64 includes a pipe 72 coupled to a main water supply and a water supply shut off valve 76.

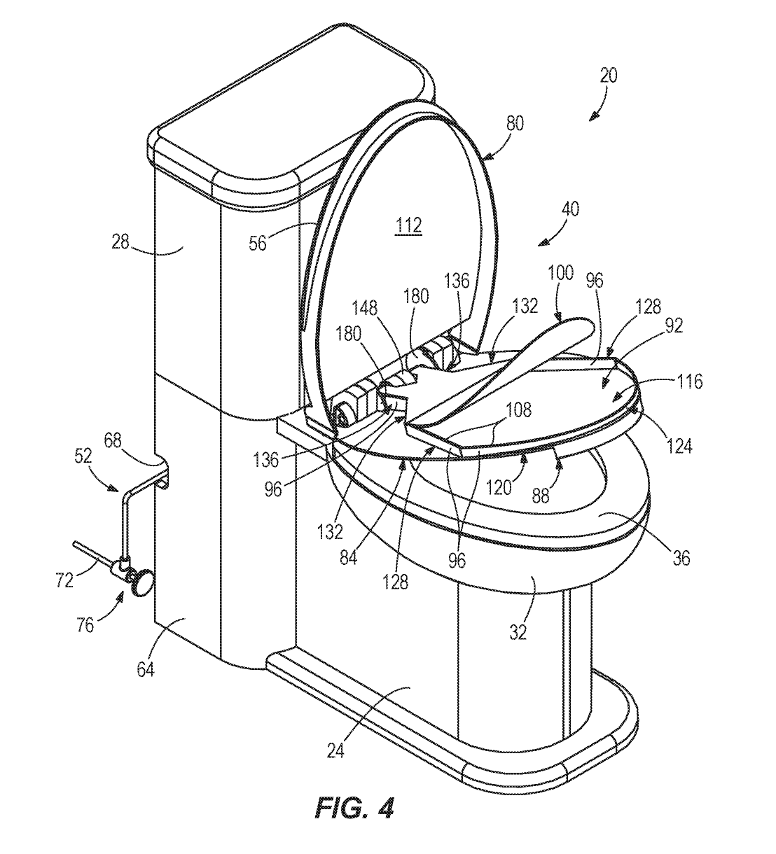

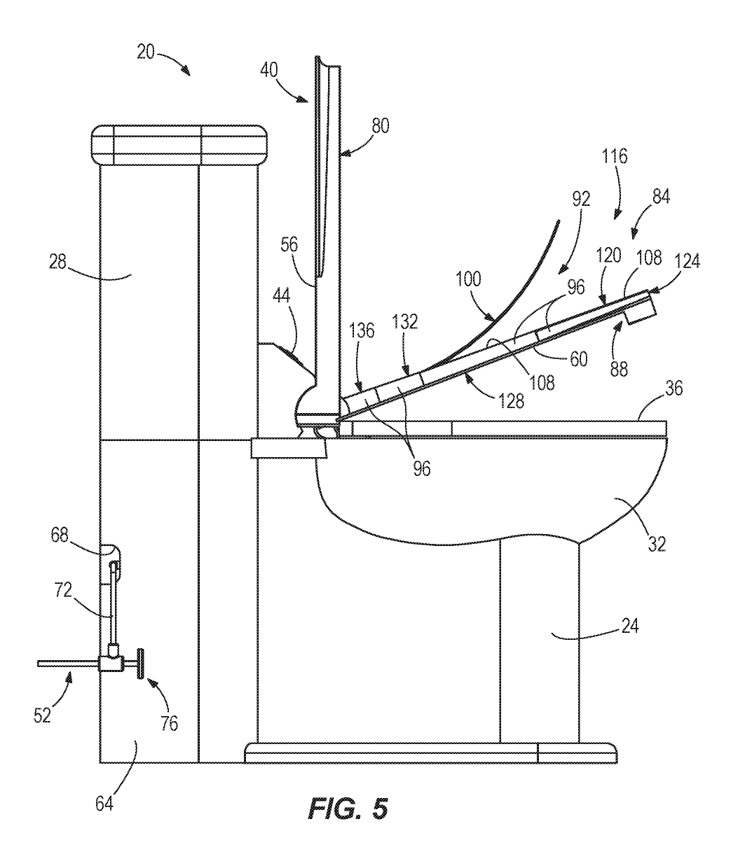

With reference to FIGS. 4 and 5, the illustrated example of the device 20 includes a toilet cover 40 that is capable of converting into a urinal to allow an individual to urinate into the toilet cover 40 from a standing position. The illustrated example of the toilet cover 40 is not intended to limit the present disclosure. Rather, the illustrated example of the toilet cover 40 is provided to demonstrate at least some of the principles of the present disclosure. The toilet cover 40 is capable of having a wide variety of shapes, sizes, configurations and functionalities to facilitate conversion into a urinal and all of such possibilities are intended to be within the spirit and scope of the present disclosure.

With continued reference to FIGS. 4 and 5, the toilet cover 40 includes a first member 80 and a second member 84 moveable relative to each other to provide the toilet cover 40 with a closed position, in which the first and second members 80, 84 are positioned together and not spaced apart (see FIGS. 1-3), and an opened position, in which the second member 84 is moved away and spaced-apart from the first member 80 (see FIGS. 4 and 5). The toilet cover 40 is converted into a urinal when the toilet cover 40 is in the opened position and the second member 84 is moved away from the first member 80. In the illustrated example, the second member 84 is rotatable relative to the first member 80 between the opened and closed positions. In other examples, the second member 84 is moveable relative to the first member 80 in a variety of other manners and all of such possibilities are intended to be within the spirit and scope of the present disclosure. The toilet cover 40 may include an engagement area 88 to assist a user with moving the second member 84 relative to the first member 80. In the illustrated example, the second member 84 includes a recess or cutout to provide a lip that may be grasped by a user. The second member 84 may include any type of engagement area 88 to assist with moving the second member 84 relative to the first member 80. For example, the second member 84 may include a projection, a handle, or any other type of feature that allows a user to grasp the second member 84. In another example, the second member 84 may not include an added engagement area to assist with movement of the second member 84 relative to the first member 80. In such an example, a user could simply grasp any portion of the second member 84.

Referring now to FIGS. 4-7, the toilet cover 40 includes a receptacle 92 in which a user may urinate. In the illustrated example, the receptacle 92 is defined by the second member 84 on a bottom of the receptacle 92, upward extending side walls 96 on sides of the receptacle 92, and a top wall 100 on a top of the receptacle 92. The second member 84, side walls 96 and top wall 100 cooperate to direct urine introduced into the receptacle 92 toward a urinal drain 104. In the illustrated example, the top wall 100 is a resilient top wall made of a resilient material. When the toilet cover 40 is in the closed position, the resilient top wall 100 is biased or forced down toward and into contact with an upper edge 108 of the side walls 96 by engagement with a bottom 112 of the first member 80. This engagement between the resilient top wall 100 and the upper edges 108 of the side walls 96 effectively seals off the receptacle 92, thereby inhibiting or decreasing urine smell that may exist within the receptacle 92 from exiting the receptacle 92 from between the first member 80 and the second member 84. When the second member 84 is moved away from the first member 80 toward the opened position, the resilient top wall 100 is naturally biased upward away from the upper edges 108 of the side walls 96 and begins to move away from the upper edges 108 of the side walls 96 as the engagement with the bottom 112 of the first member 80 is removed. The resilient top wall 100 has a limit position to which it moves away from the upper edges 108 of the side walls 96. This limiting position defines a size of an opening 116 into the receptacle 92 into which a user may urinate. The limiting position of the top wall 100 may be a wide variety of positions and may be determined in a wide variety of manners with all of such possibilities intended to be within the spirit and scope of the present disclosure. For example, the resilient top wall 100 may be made of a wide variety of resilient materials having different quantities of resiliency, the resilient top wall 100 may be coupled to the second member 84 in a variety of manners that allow the top wall 100 to move different distances away from the second member 84, etc.

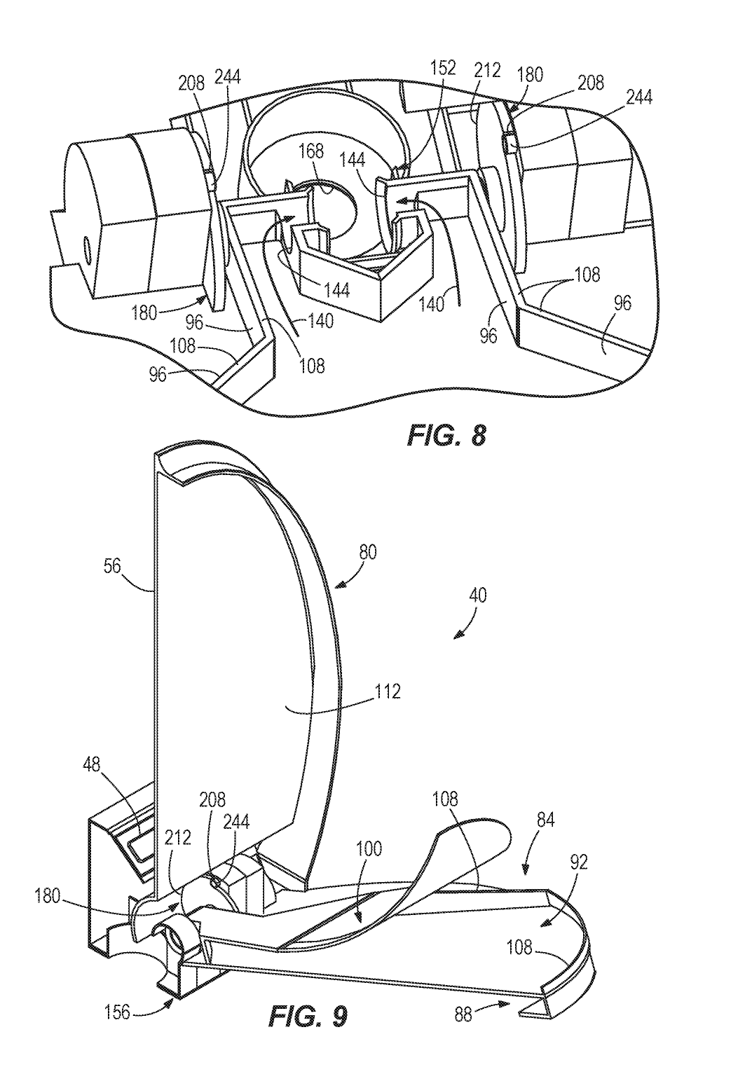

With continued reference to FIGS. 4-7 and additional reference to FIG. 8, the side walls 96 of the second member 84 are oriented to assist with directing urine into the urinal drain 104. In the illustrated example, the side walls 96 include a first portion 120 following a front edge 124 of the second member 84, a second portion 128 extending from the first portion 120 in a direction toward the urinal drain 104, a third portion 132 extending from the second portion 128 toward the urinal drain 104, and a fourth portion 136 extending from the third portion 132 toward the urinal drain 104. In the illustrated example, the third portion 132 of the side walls 96 converge as they approach the urinal drain 104. The fourth portion 136 of the side walls 96 separate the receptacle 92 into two paths 140 (see FIG. 8) and include two apertures or holes 144, one aperture or hole 144 at an end of each path 140, which allows urine to pass through the side walls 96 and exit the receptacle 92 into the urinal drain 104. It should be understood that the illustrated example of the side walls 96 is not intended to be limiting and is provided to demonstrate at least some of the principles of the present disclosure. The side walls 96 may have any shape, size, configuration and functionality to direct urine toward the urinal drain 104 and all of such possibilities are intended to be within the spirit and scope of the present disclosure. In the illustrated example, the toilet cover 40 also includes a support cover 148 that may be coupled to at least one of a support 152 and the second member 84. The support cover 148 covers a space over the support 152 and between the holes 144 in the second member 84.

Referring now to FIGS. 4-13, movement of the toilet cover 40 relative to the toilet bowl 32 and movement of the second member 84 relative to the first member 80 will be described. The toilet cover 40 includes a base 156 having a pair of hubs 160 with each hub 160 defining an aperture 164 therethrough. The apertures 164 are aligned with each other along a common axis. The base 156 also includes a urinal drain opening 168 defined therein aligned with the urinal drain 104 to allow urine to pass through the base 156 and into the urinal drain 104. The base 156 further includes a support 152 for engaging and supporting the portion of the second member 84 defining the holes 144 therein. The support 152 may also assist with directing urine toward the urinal drain opening 168 defined in the base 156. The support 152 includes a pair of arcuate cutouts or recesses 172 that are shaped complementary to a shape of the portion of the second member 84 defining the holes 144. The base 156 further includes a pair of locking or engagement members 176 configured to limit movement of the second member 84 relative to the first member 80 (described in further detail below).

The second member 84 includes a pair of cams 180 with each cam 180 defining an aperture 184 therethrough. One aperture 184 in one of the cams 180 aligns with one aperture 164 in one of the hubs 160 and the other aperture 184 in the other cam 180 aligns with the aperture 164 of the other hub 160. The toilet seat 36 includes a pair of projections 188 with each projection 188 defining an aperture 192 therethrough. The apertures 192 in the projections 188 align with respective apertures 164, 184 in the hubs 160 and the cams 180. The first member 80 of the toilet cover 40 also includes a pair of hubs 196 with each hub 196 defining an aperture 200 therethrough. All of the apertures 164, 184, 200 are respectively aligned with each other to receive one of two axles, pins or shafts 204 therein. The pins 204 facilitate rotation of the toilet seat 36 and the first and second members 80, 84 of the toilet cover 40 relative to each other and to the toilet bowl 32.

With continued reference to FIGS. 4-13, the toilet cover 40 is configured to control movement of the second member 84 relative to the first member 80 in a preferred manner that assists with the functionality of the toilet cover 40. To this end, the toilet cover 40 is designed to provide the urinal feature of the device 20 at a preferred time and in a preferred manner. In other words, the toilet cover 40 prevents a user from separating the first and second members 80, 84 at undesirable times and locations. This capability ensures the urinal features of the device 20 are used properly.

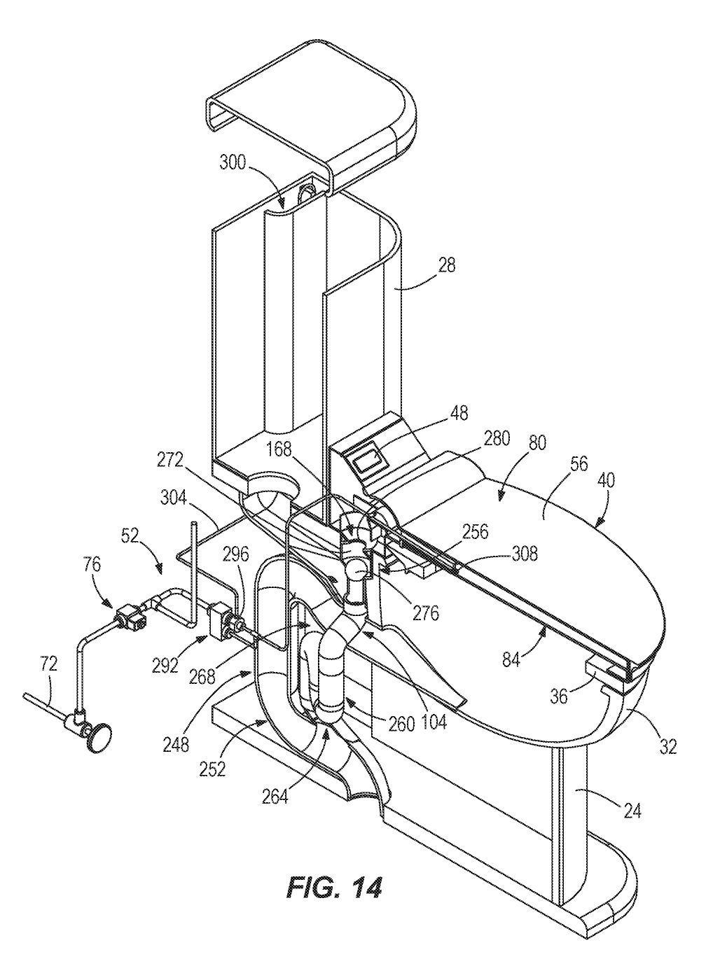

In the illustrated example, to separate the first and second members 80, 84 to provide the urinal feature, the toilet cover 40 is first moved to a fully upward position (see FIG. 2). This fully upward position is also represented in an elevational view in FIG. 13. Each cam 180 has a profile that includes a notch, lip, catch or abutment 208, and an arcuate surface 212 gradually curving from the first abutment 208 to a flat surface 216 of the cam 180. The arcuate surface 212 provides varying thickness of the cam 180 relative to a rotational axis 220 of the second member 84. The rotational axis 220 extends through a longitudinal center of the pins 204 and is also a rotational axis 220 for the first member 80 and the toilet seat 36. In the illustrated example, the curved surface 212 provides a first thickness 224 and the flat surface 216 provides a second thickness 228 less than the first thickness 224 (see FIG. 11). The thicknesses 224, 228 provided by the cams 180 may be a wide variety of thicknesses and all of such possibilities are intended to be within the spirit and scope of the present disclosure. The first member 80 includes a pair of notches, lips, catches or abutments 232, which are configured to selectively engage the engagement members 176. Each engagement member 176 is resilient and includes an enlarged portion 236 configured to engage respective abutments 232 on the first member 80. As the toilet cover 40 moves to the fully upward position, the abutments 232 of the first member 80 bias against a top of the engagement members 176 causing the engagement members 176 to move downward. The abutments 232 will eventually move past the enlarged portions 236 of the engagement members 176, thereby allowing the engagement members 176 to move upward into respective cavities 240 defined by the abutments 232. Once the engagement members 176 are past the abutments 232 of the first member 80, the enlarged portions 236 of the engagement members 176 engage respective curved surfaces 212 of the cams 180 as illustrated in FIG. 13.

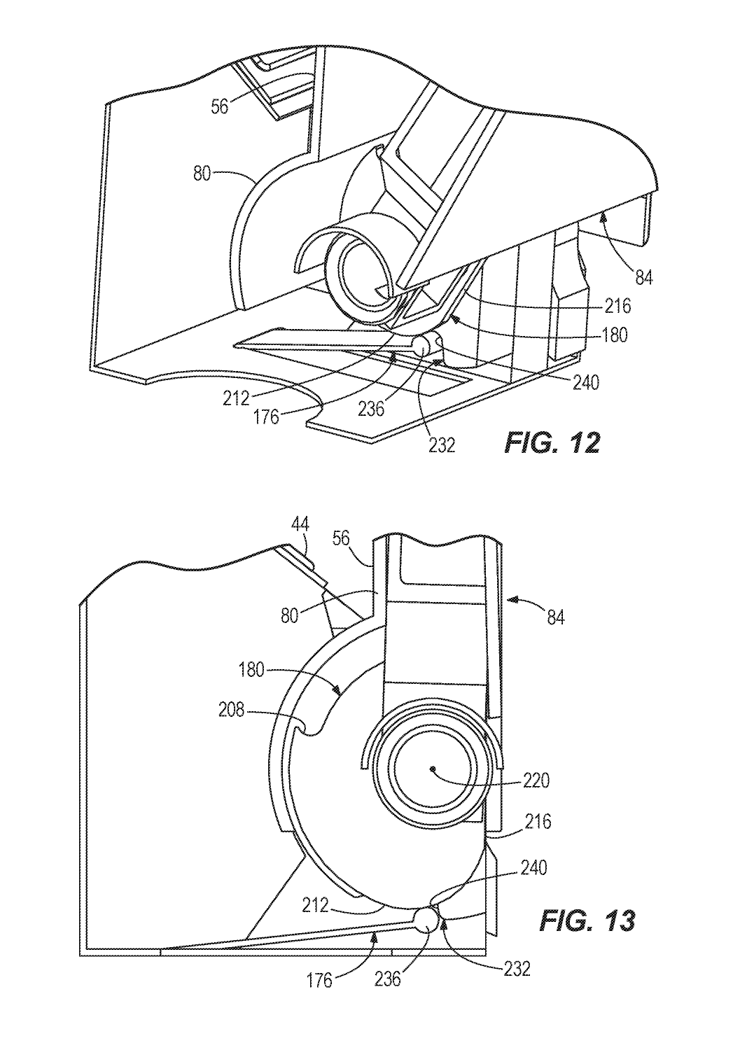

In this fully upward position, the second member 84 is now capable of rotating relative to the first member 80. The first member 80 is maintained in its fully upward position by the engagement members 176 engaging the abutments 232 in the first member 80 (see FIG. 12). The second member 84 may be rotated downward away from the first member 80 while the first member 80 remains in its fully upward position (see FIG. 12). The thickness 228 of the cams 180 is such that the engagement members 176 remain in the cavities 240 defined by the abutments 232 in the first member 80. The flat surface 216 in the profile of each cam 180 provides this desirable thickness 228.

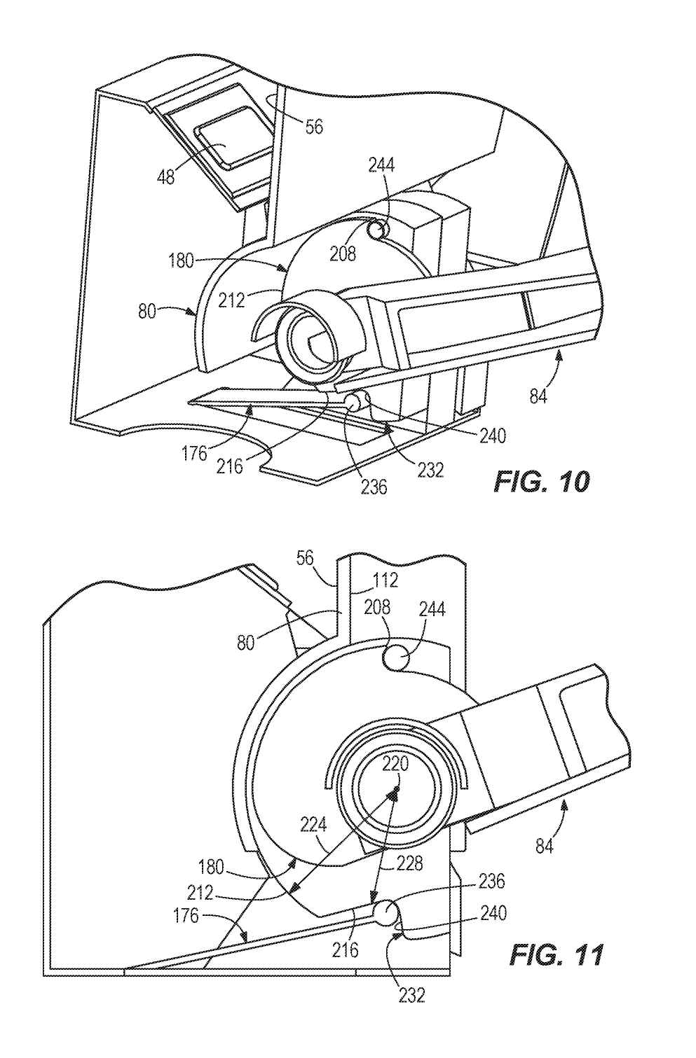

The downward rotation of the second member 84 relative to the first member 80 may be limited to provide a preferred positioning of the second member 84 and, therefore, a preferred positioning of the urinal feature of the device 20. In the illustrated example, the toilet cover 40 includes a pair of stop members, limiting members or engagement members 244 coupled to the first member 80 and in a position to engage the abutments 208 of the cams 180. The second member 84 is rotated downward away from the first member 80 about the rotational axis 220 until the abutments 208 of the second member 84 engage the stop members 244 (see FIGS. 10 and 11). The position of the second member 84 may be limited in a variety of positions and all of such possibilities are intended to be within the spirit and scope of the present disclosure. In the illustrated example, the second member 84 is limited at about 20 degrees relative to the top of the toilet bowl 32 or a horizontal plane. In other examples, the second member 84 may be limited between about 10 degrees and about 30 degrees relative to a horizontal plane. In still other examples, the second member 84 may be limited between about 5 degrees and about 50 degrees relative to a horizontal plane. The limited position of the second member 84 may be varied by changing the shape, size or configuration of the cam 180 (e.g., by moving the abutments on the cams), by moving the position of the stop members 244, or any of a wide variety of other manners. In one example, the toilet cover 40 may include the capability of adjusting the limited position of the second member 84. In such an example, the stop members 244 may be moveable between a plurality of positions, the abutments 208 on the cams 180 may be moveable between a plurality of position relative to the remainder of the cams 180, or the cams 180 themselves may be moveable relative to the second member 84, such as, for example, by rotating, sliding, translating, etc. The second member 84 may also be limited at a desired deposition in a variety of manners other than by the abutment and stop member interaction, and all of such possibilities are intended to be within the spirit and scope of the present disclosure.

As the second member 84 rotates away from the first member 80, the top wall 100 of the receptacle 92 begins to move away from the second member 84 due to the resiliency of the top wall 100. This movement by the top wall 100 provides the opening 116 into the receptacle 92, which ultimately provides the urinal feature of the device 20. In the limited position of the second member 84, the top wall 100 is in a fully opened position, thereby rendering the receptacle 92 fully opened. When a user is finished utilizing the urinal feature of the device 20, a user may rotate the second member 84 back toward the first member 80. As the second member 84 moves toward the first member 80, the abutments 208 in the cams 180 move away from the stop members 244 and the cams 180 begin to bias against the engagement members 176 (see FIG. 12). The second member 84 continues to rotate toward the first member 80 until the second member 84 is in the fully upward position (see FIG. 13). In this position, the first thickness 224 of the cam 180 engages the engagement members 176, thereby biasing the engagement members 176 sufficiently downward to allow the abutments 232 of the first member 80 to pass by the engagement members 176. With the engagement members 176 in this position, the first and second members 80, 84 may be rotated downward together relative to the toilet bowl 32.

With reference to FIGS. 14-21, the illustrated example of a drainage system 248 of the device 20 will be described. It should be understood that the illustrated example of the draining system is only one example of the many different types of drainage systems that may be included in the device and all of such possibilities are intended to be within the spirit and scope of the present disclosure.

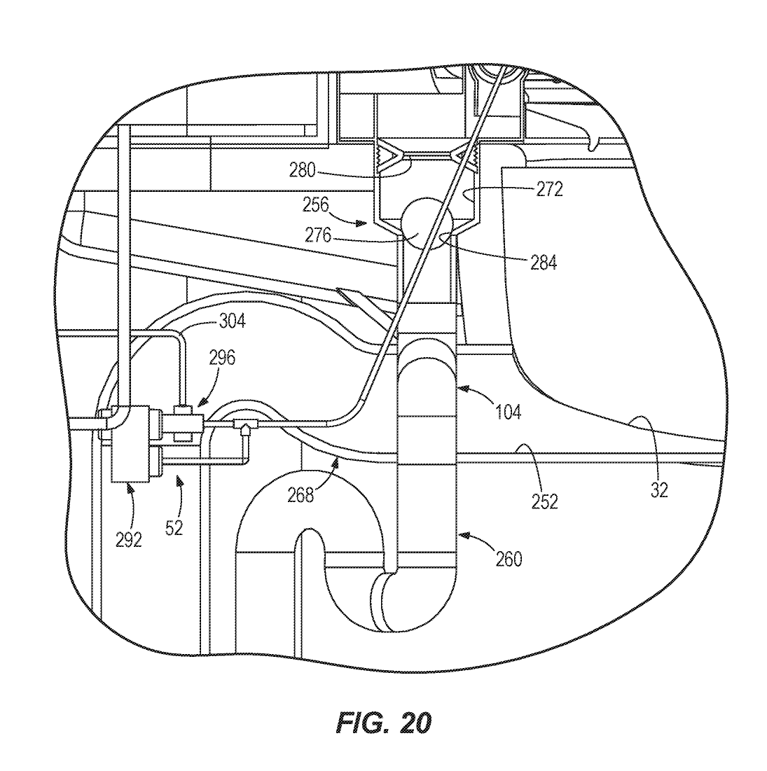

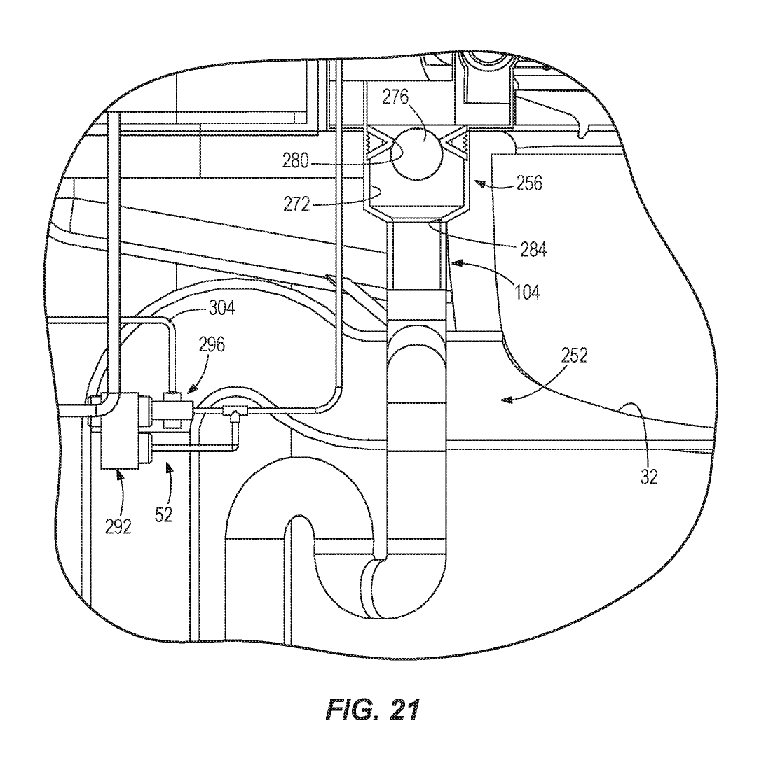

In the illustrated example, the device 20 includes a first drain or urinal drain 104 and a second drain or toilet drain 252. The urinal drain 104 is configured to receive urine from the toilet cover 40 and through the urinal opening 168 defined in the toilet cover base 156. The urinal drain 104 includes a valve 256, a urinal trap 260 and an end 264 in fluid communication with the toilet drain 252. The toilet drain 252 is in fluid communication with the toilet bowl 32 and includes its own toilet trap 268. In the illustrated example, the urinal drain 104 couples to the toilet drain 252 downstream of the toilet trap 268, but before or upstream of where the toilet drain 252 exits the base 24 of the device 20. The valve 256 is configured to inhibit backflow of liquid through the urinal drain 104 and out of a top end of the urinal drain 104 into the toilet cover 40. In the illustrated example, the valve 256 is a ball valve 256 and includes a chamber or valve chamber 272 and a ball 276 positioned in the chamber 272. The chamber 272 includes a first seat or first opening 280 at a top thereof (which may be the urinal opening defined in the toilet cover base) and a second seat or second opening 284 at a bottom. The first and second openings 280, 284 are smaller in diameter than a diameter of the ball 276 to prevent the ball 276 from exiting the chamber 272 and entering either the urinal drain 104 downstream of the chamber 272 or the toilet cover 40. When urine enters the chamber 272 from above via the toilet cover 40, the ball 276 floats in the urine allowing the urine to pass below the ball 276 and into the urinal drain 104 downstream of the chamber 272. In some cases, backpressure may occur in the urinal drain 104 such as, for example, by plunging the toilet bowl 32 if the toilet drain 252 is plugged. If such backpressure occurs in the urinal drain 104, the ball 276 will be forced upward into contact with the first opening 280 to create a seal (see FIG. 21), thereby inhibiting fluid from exiting the chamber 272 and into the toilet cover 40. When the backpressure ceases, the ball 276 will fall down back into contact with the second opening 284 in the chamber 272 (see FIGS. 19 and 20).

Referring now to FIGS. 1, 3, 14 and 15, the illustrated example of the plumbing 52 and associated functionality of the device 20 will be described. The device 20 is capable of being flushed or otherwise cleaned in a plurality of manners. If only the toilet bowl 32 is used, only the toilet bowl 32 will be flushed or evacuated to remove the remanence therein. It may not be desirable to flush or evacuate the toilet cover 40 or urinal feature in this instance since the toilet cover 40 or urinal feature was not used. To flush only the toilet bowl 32, a user may actuate a conventional flush handle on a side of the reservoir tank 28 or any other conventional toilet bowl flushing technique. Actuation of the flush handle causes the liquid and remanence in the toilet bowl 32 to evacuate through the toilet drain 252. Water present in the reservoir tank 28 will then empty into the toilet bowl 32 to refill the toilet bowl 32. Water will then be routed to the reservoir tank 28 via the main water pipe to refill the reservoir tank 28 for the next flush of the toilet bowl 32.

If the toilet cover 40 or urinal feature is used, only the toilet cover 40 or urinal feature may be flushed. It may not be desirable to flush or evacuate the toilet bowl 32 in this instance since the toilet bowl 32 was not used. Only flushing the urinal feature when the urinal feature is used saves a significant amount of water versus flushing the toilet bowl 32 in combination with the urinal feature. Additionally, by providing the urinal feature with the device 20, a significant amount of water is saved when compared to a conventional toilet where a user urinates into the toilet bowl 32 and the entire toilet bowl 32 must be flushed to evacuate the urine therein.

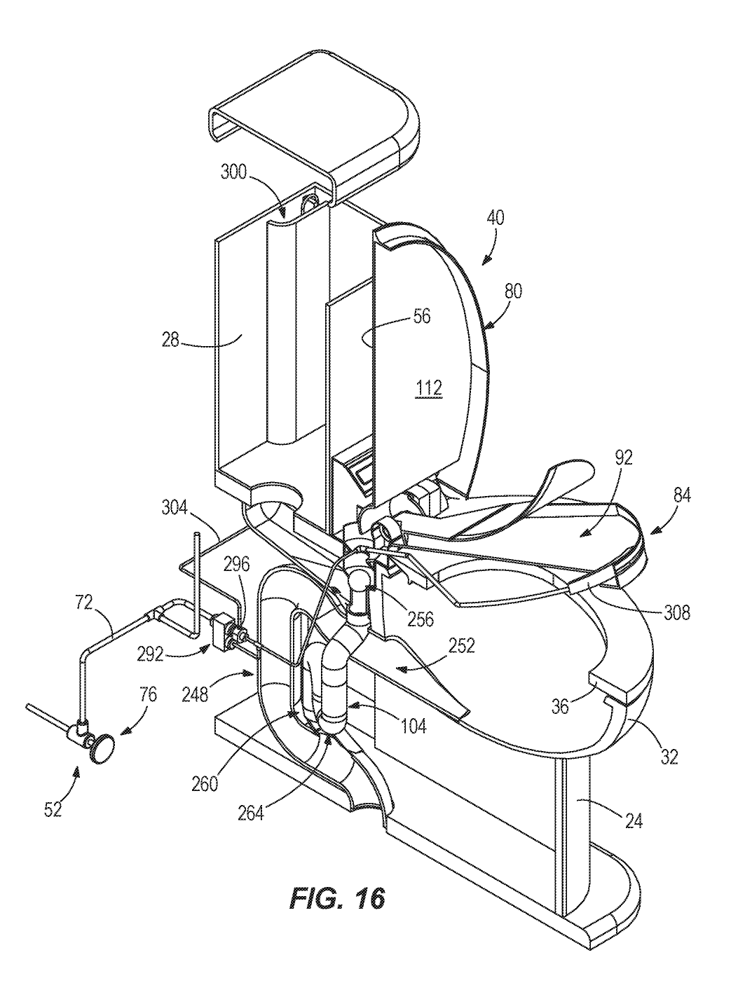

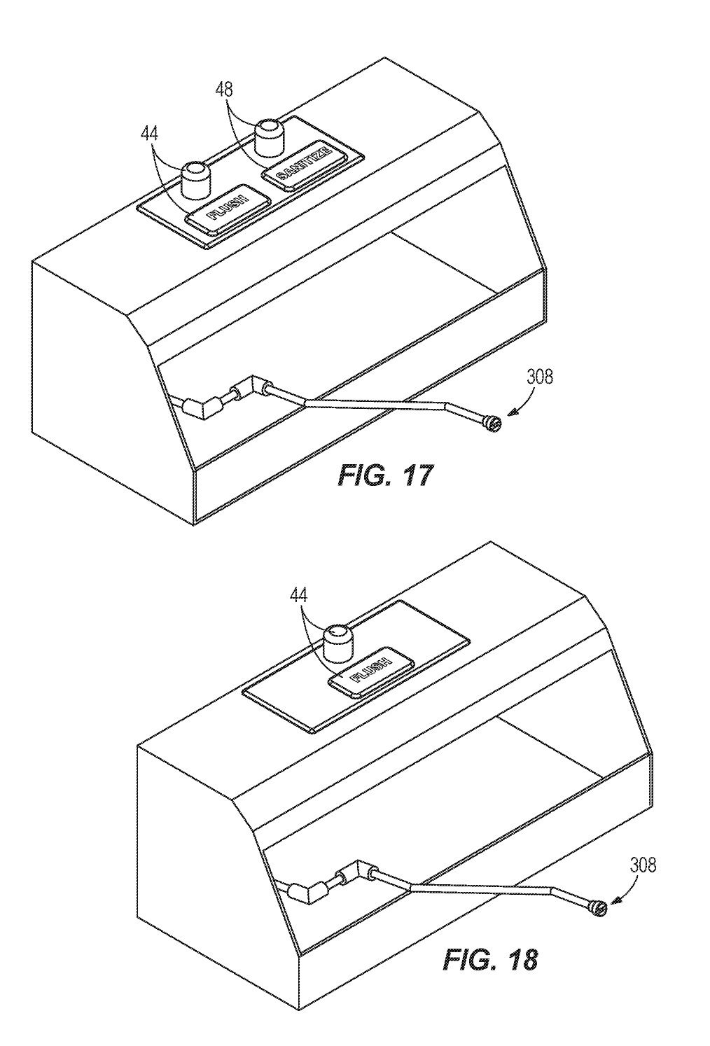

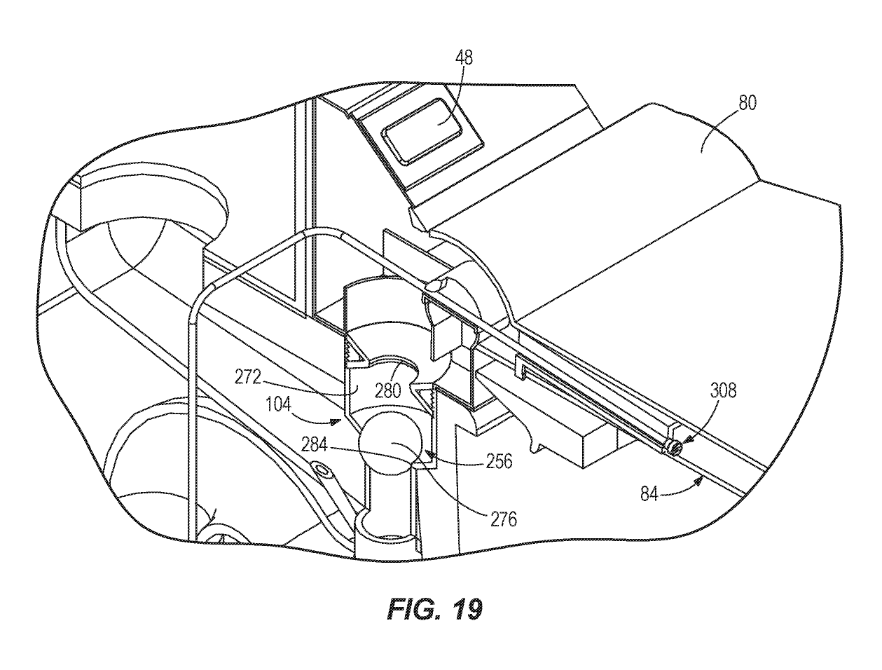

The urinal feature may be flushed in two manners. A first manner of flushing utilizes a sanitizer or cleaning solution different than just water and a second manner of flushing utilizes water. In the illustrated example, to flush the urinal feature using sanitizer, a user actuates a first actuator or sanitizer actuator 48. Actuation of the sanitizer actuator 48 activates a solenoid 292 and injector 296 to draw liquid or sanitizer from a sanitizer solution reservoir 300 via sanitizer piping 304 and spray the sanitizer into the receptacle 92 via a nozzle 308. In the illustrated example, the nozzle 308 is orientated near an end of the receptacle 92 adjacent the urinal drain 104. In other examples, with reference to FIG. 16, the nozzle 308 may be oriented at an end of the receptacle 92 distal the urinal drain 104. In yet other examples, the nozzle 308 may be positioned anywhere within the receptacle 92 and all of such possibilities are intended to be within the spirit and scope of the present disclosure. In the illustrated example, the sanitizer reservoir 300 is housed within the reservoir tank 28 of the device 20. In other examples, the sanitizer reservoir may be positioned externally of the reservoir tank 28. The sanitizer reservoir 300 needs to be refilled with sanitizer as the sanitizer is depleted.

The second manner of flushing the urinal feature includes water. In the illustrated example, the water used to clean the receptacle 92 may originate from a variety of sources including, but not limited to, the main water pipe 72, the reservoir tank 28, a tank separate from the reservoir tank 28, or any of a wide variety of other sources. In the illustrated example, to flush the urinal feature using water, a user actuates a second actuator or water actuator 44, which activates the solenoid 292. The solenoid 292 is a three-way or more-way valve that is capable of drawing the water from any of these types of water sources and bypassing the injector 296, which is in fluid communication with the separate sanitizer reservoir 300.

In other examples, with reference to FIG. 18, the urinal feature may only include a single flushing capability. In such an example, water is the only liquid used to flush or clean the receptacle 92 in the toilet cover 40. The water may originate from any of the water sources described above and be routed to the receptacle 92 in any manner including, but not limited to, those described above.

The device 20 is configured to include an overflow feature, device or assembly to address overflow situations associated with the device 20. In one example, the device 20 may include one or more sensors at least partially positioned in the toilet bowl 32. The one or more sensors may be oriented in the toilet bowl 32 at a position where it/they will be contacted by liquid within the toilet bowl 32 at an undesirable or out of the ordinary high liquid level. In one example, the one or more sensors are positioned at a same level within the toilet bowl 32. In another example, a first sensor may be positioned at a first level with the toilet bowl 32 and a second sensor may be positioned at a different level than the first level that is higher than the first level. The one or more sensors preferably will not be contacted by liquid in the toilet bowl 32 at normal operating levels of the liquid within the toilet bowl 32. The device 20 will also include one or more water shut off valves 76 in electrical communication with the one or more sensors. The one or more water shut off valves 76 may be configured to shut off one or both of the water supply to the reservoir tank 28 and/or stop the water flow from the reservoir tank 28 to the toilet bowl 32.

In some examples, the device 20 may also include a communication device in electrical communication with the one or more sensors. The communication device is configured to communicate a signal to a second communication device. The second communication device is configured to perform one or more functions based on the information or data received from the communication device. In one example, the communication device is hardwired with the second communication device and information or data is transmitted between the communication device and the second communication device over one or more wires. In another example, the communication device and the second communication device each include at least one network interface and communicate with each other wirelessly over one or more networks via the network interfaces. Examples of networks over which the communication device and the second communication device communicate include, but are not limited to a cellular network, Wi-Fi, the Internet, a local area network (LAN), a wide area network (WAN), or any other type of network. The communication device and second communication device include network interfaces complementary to the one or more networks over which communication occurs.

As indicated above, the second communication device is configured to perform a wide variety of functions including, but not limited to, one or more of providing an audible noise or alarm (for example, a speaker or other audio device emitting a sound), providing a visual indicator or alarm (for example, illuminating one or more lights, displaying visual indicia on a display or monitor), transmitting information or data back to the communication device over the one or more networks to instruct one or more components of the overflow assembly to perform a function, transmitting information or data to a 3rd party communication device where a 3rd party may be notified of the information or data transmitted from the sensor and the communication device (for example, a maintenance entity, plumbing entity, corporate headquarters, etc.). For example, the second communication device may communicate information or data over the one or more networks to instruct the one or more overflow shut off valves to shut off water supply. The overflow assembly may either be electrically connected to an AC power source such as, for example, a wall electrical outlet or hardwired to an AC power source, or may include its own power source such as, for example, a DC power source (for example, a battery). If an AC power source is utilized, the overflow assembly may include an AC/DC converter.

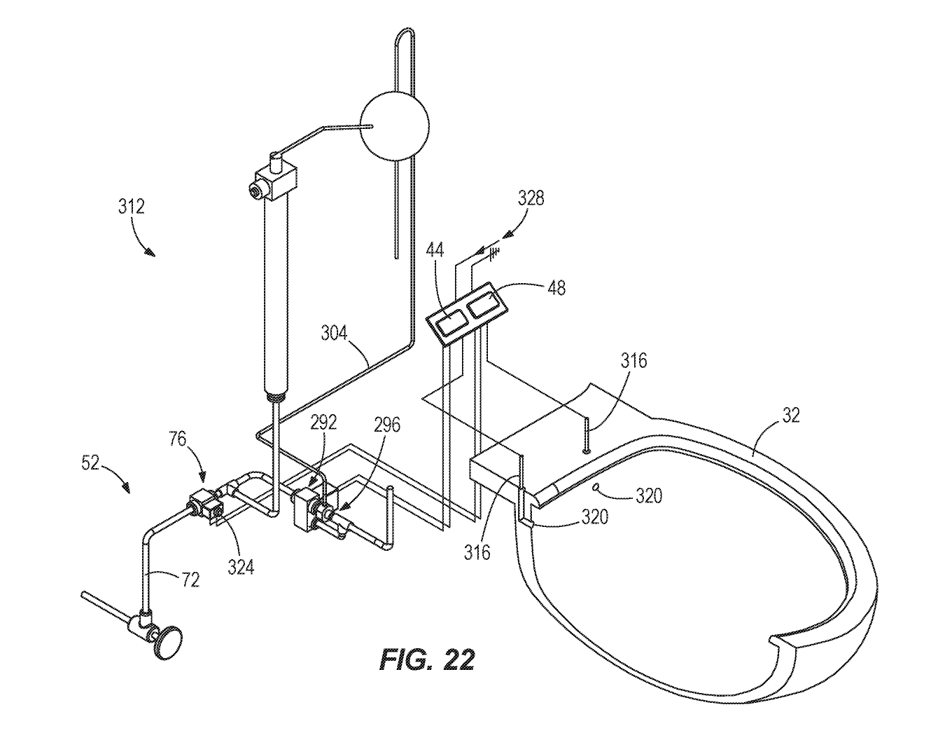

With reference to FIG. 22, one example of an overflow assembly 312 is illustrated. In this illustrated example, the overflow assembly 312 includes a pair of sensors 316 (for example, electrodes) positioned in cavities 320 defined in the toilet bowl 32 and a pair of shut off valves 76. In the illustrated example, the sensors 316 are positioned at a same level and when liquid rises to the level of and fills the cavities 320, the liquid closes a circuit between the two sensors 316. The sensors 316 and cavities 320 are oriented at a level associated with an overflow condition or a condition where the toilet drain 252 is clogged/plugged. The two sensors 316 are in electrical communication with the water shut off valves 76. When the circuit is closed or the sensors 316 otherwise sense the presence of liquid, one or both of the shut off valves 76 are actuated to shut off water supply. One of the shut off valves 76 is positioned on the main water supply pipe 72 to shut off the main water supply and the second shut off valve 76 is positioned on the reservoir tank water supply to shut off water supply to the reservoir tank 28. The shut off valves 76 may each include an actuator 324 that may be manually actuated to reopen the valve 76 and allow water to flow again. The overflow assembly 312 also includes a DC power source 328 such as, for example, a battery, for powering the electrical components of the overflow assembly 312. The battery 328 may also power a sanitizing flush capability of the toilet cover 40 or urinal feature of the device 20. A user may replace the battery 328 as desired.

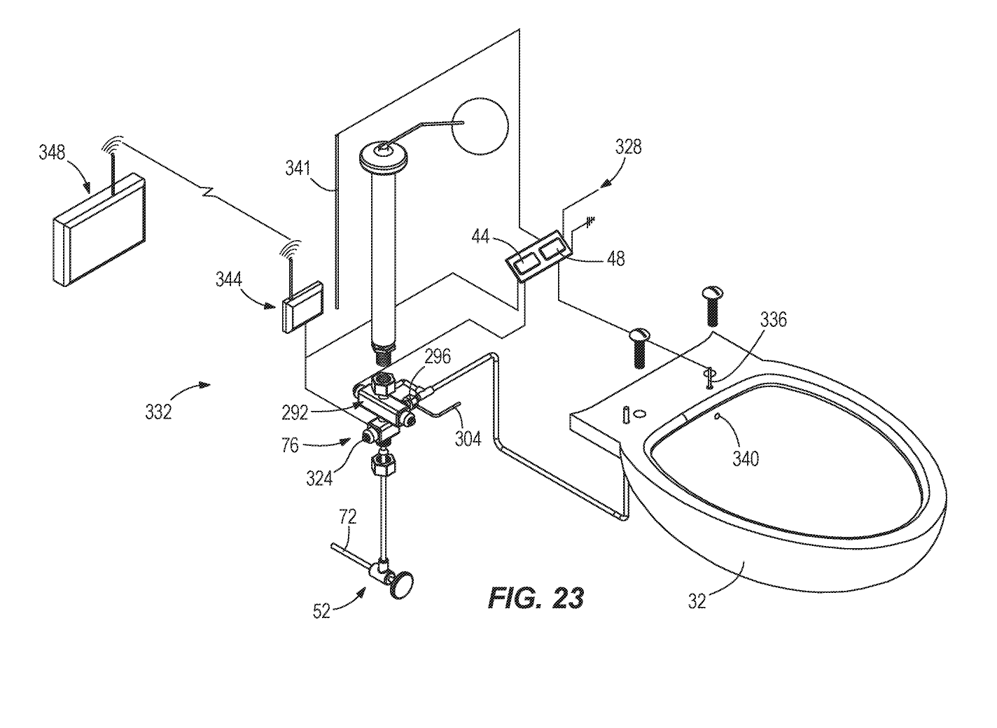

Referring now to FIG. 23, one example of an overflow assembly 332 is illustrated. In this illustrated example, the overflow assembly 332 includes a sensor 336 positioned in a cavity 340 defined in the toilet bowl 32 and a shut off valve 76. In the illustrated example, the sensor 336 is positioned at a level associated with an overflow condition or a condition where the toilet drain 252 is clogged/plugged. The sensor 336 is in electrical communication with the water shut off valve 76. When the circuit is closed or the sensor 336 otherwise senses the presence of liquid, the shut off valve 76 is actuated to shut off water supply. The shut off valve 76 is positioned on the main water supply pipe 72 to shut off the main water supply. The shut off valve 76 may include an actuator 324 that may be manually actuated to reopen the valve 76 and allow water to flow again.

With continued reference to FIG. 23, the overflow assembly 332 may also include a first communication device 344 in electrical communication with the sensor 336. The first communication device 344 is configured to communicate a signal to a second communication device 348. The second communication device 348 is configured to perform one or more functions based on the information or data received from the first communication device 344. In one example, the first communication device 344 is hardwired with the second communication device 348 and information or data is transmitted between the first communication device 344 and the second communication device 348 over one or more wires. In the illustrated example, the first communication device 344 and the second communication device 348 each include at least one network interface and communicate with each other wirelessly over one or more networks via the network interfaces. Examples of networks over which the first and second communication devices 344, 348 communicate include, but are not limited to a cellular network, Wi-Fi, the Internet, a local area network (LAN), a wide area network (WAN), or any other type of network. The first and second communication devices 344, 348 include network interfaces complementary to the one or more networks over which communication occurs.

As indicated above, the second communication device 348 is configured to perform a wide variety of functions including, but not limited to, one or more of providing an audible noise or alarm (for example, a speaker or other audio device emitting a sound), providing a visual indicator or alarm (for example, illuminating one or more lights, displaying visual indicia on a display or monitor), transmitting information or data back to the first communication device 344 over the one or more networks to instruct one or more components of the overflow assembly 332 to perform a function, transmitting information or data to a 3rd party communication device where a 3rd party may be notified of the information or data transmitted from the sensor and the first communication device 344 (for example, a maintenance entity, plumbing entity, corporate headquarters, etc.). For example, the second communication device 348 may communicate information or data over the one or more networks to instruct the overflow shut off valve 76 to shut off the water supply. The overflow assembly 332 may either be electrically connected to an AC power source such as, for example, a wall electrical outlet or hardwired to an AC power source, or may include its own power source such as, for example, a DC power source 328 (for example, a battery). If an AC power source is utilized, the overflow assembly may include an AC/DC converter. The second communication device 348 may also communicate information or data over the one or more networks to the first communication device 344, which then communicates information or data to the overflow shut off valve 76 to reopen after it has been closed.

With continued reference to FIG. 23, the assembly 332 also includes a second sensor 341 positioned in the reservoir tank. The second sensor 341 is positioned in the reservoir tank to identify a leak in the reservoir tank. In some instances, the reservoir tank may have a slow or rapid leak that may result in liquid exiting the toilet and flowing into/onto the wall and/or the floor. Additionally, a water leak in the reservoir tank may result in the reservoir tank containing insufficient water to facilitate flushing of the toilet. The reservoir tank may leak for a variety of reasons. In one example, a toilet tank flapper may leak (i.e., not create a sufficient seal) or may be stuck in an open position. The second sensor 341 is positioned within the reservoir tank at a level that is determined to be too low. This level is variable depending on the use of the toilet, the environment in which the toilet is used, the user's/owner's own preference, or any of a wide variety of other reasons.

In the illustrated example, the second sensor 341 is in electrical communication with the first communication device 344. The first communication device 344 is configured to communicate a signal to the second communication device 348. The second communication device 348 is configured to perform one or more functions based on the information or data received from the first communication device 344 associated with the second sensor 341. In one example, the first communication device 344 is hardwired with the second communication device 348 and information or data associated with the second sensor 341 is transmitted between the first communication device 344 and the second communication device 348 over one or more wires. In the illustrated example, the first communication device 344 and the second communication device 348 each include at least one network interface and communicate with each other wirelessly over one or more networks via the network interfaces. Examples of networks over which the first and second communication devices 344, 348 communicate include, but are not limited to a cellular network, Wi-Fi, the Internet, a local area network (LAN), a wide area network (WAN), or any other type of network. The first and second communication devices 344, 348 include network interfaces complementary to the one or more networks over which communication occurs.

As indicated above, the second communication device 348 is configured to perform a wide variety of functions including, but not limited to, one or more of providing an audible noise or alarm (for example, a speaker or other audio device emitting a sound), providing a visual indicator or alarm (for example, illuminating one or more lights, displaying visual indicia on a display or monitor), transmitting information or data back to the first communication device 344 over the one or more networks to instruct one or more components of the overflow assembly 332 to perform a function, transmitting information or data to a 3rd party communication device where a 3rd party may be notified of the information or data transmitted from the second sensor 341 and the first communication device 344 (for example, a maintenance entity, plumbing entity, corporate headquarters, etc.). For example, the second communication device 348 may communicate information or data over the one or more networks to instruct the overflow shut off valve 76 to shut off the water supply, to instruct the water supply to refill the reservoir tank, etc. The overflow assembly 332 may either be electrically connected to an AC power source such as, for example, a wall electrical outlet or hardwired to an AC power source, or may include its own power source such as, for example, a DC power source 328 (for example, a battery). If an AC power source is utilized, the overflow assembly may include an AC/DC converter. The second communication device 348 may also communicate information or data over the one or more networks to the first communication device 344, which then communicates information or data to the overflow shut off valve 76 to reopen after it has been closed, to the water supply to refill the reservoir tank, etc.

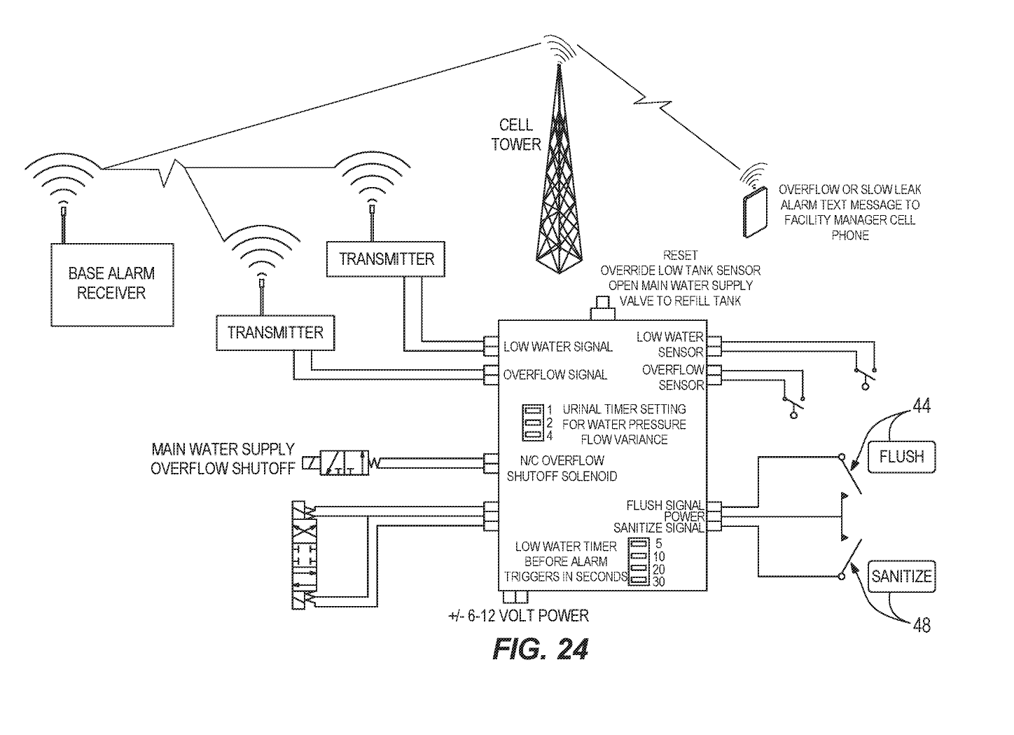

With reference to FIG. 24, one example of a schematic diagram representing at least a portion of the device 20 is illustrated. This example is not intended to be limiting upon the present disclosure, but is rather provided to demonstrate at least some of the principles of the present disclosure. The device 20 is capable of being schematically represented in a variety of other manners and all of such possibilities are intended to be within the spirit and scope of the present disclosure.

The device 20 is configured to include a urinal timer and a plurality of switches. In one example, the timer capability may be used to compensate for water pressure coming to the toilet and the urinal may need 12 ounces of water to flush. Water pressure may vary by city, town, etc., or if water originates from a private well. The plurality of switches determine an amount of time one or more flush valve(s) of the toilet stay open. The plurality of switches may be set individually or in sets. In one example, a first switch is set to 1 second of time, a second switch is set to 2 seconds of time, the first and second switches together equal 3 seconds of time, and first, second and fourth switches are set to 7 seconds of time. These switches may cooperate with the second sensor or low water sensor. These switches cooperate to establish an amount of time required to fill the reservoir tank before the second sensor would check for a low water alarm. In one example, once the toilet flushes, the second sensor would open a main water valve to refill the reservoir tank and the timer would start counting. The timer counts until it reaches a set time on the plurality of switches. After the time is reached, the reservoir tank would be filled and the main water valve will be turned off. At this time, if the second sensor still does not detect water in the reservoir tank, the second sensor will trigger a low water alarm. If second sensor does detect water, then the reservoir tank is sufficiently full and the second sensor will not create a low water alarm. Since the main water valve is closed at this time, water is not allowed into the reservoir tank. If the flapper valve of the toilet has a small leak, it will eventually drain the tank. When the second sensor detects the absence of water in the reservoir tank, the second sensor will trigger or initiate a low water alarm. In some instances, a user may not have time to fix the leak. In such instances, in one example, the user may actuate a resent button to refill the reservoir tank.

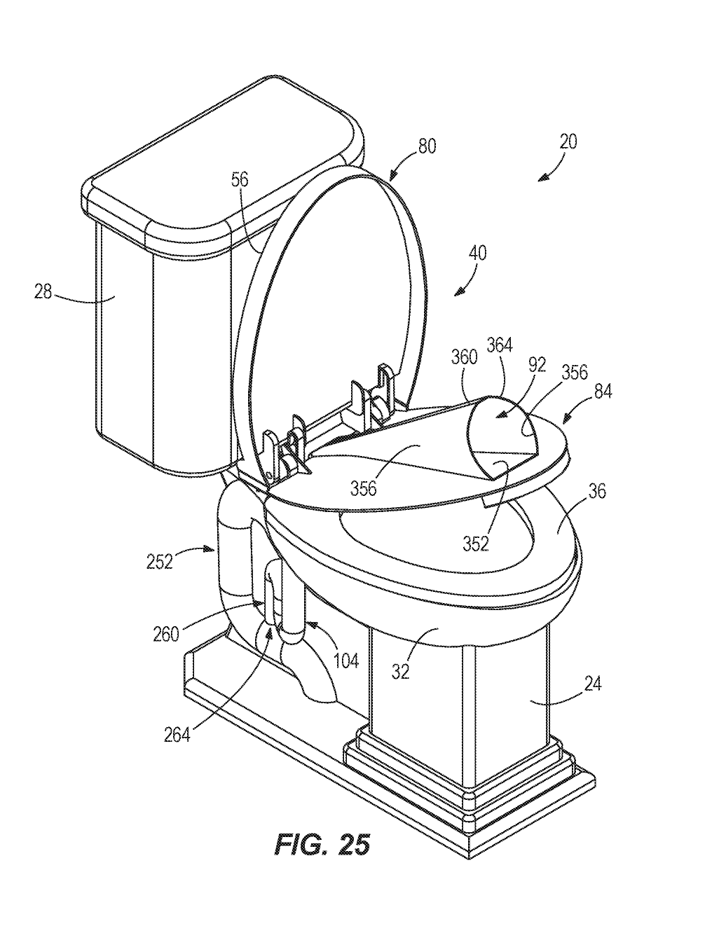

Referring now to FIG. 25, another example of the device 20 is illustrated. Similar components between the example of the device 20 illustrated in previous figures are represented by the same reference numbers. In this illustrated example, the receptacle 92 has a different configuration than the receptacle 92 illustrated in some of the previous figures. For example, the receptacle 92 in this illustrated example is made of a resilient material on a top, bottom and sides of the receptacle 92. The receptacle 92 generally has a funnel or frusto-conical shape with a flat bottom 352, arcuate sides 356 and a flat top 360. The bottom 352 of the receptacle 92 is coupled to the top of the second member 84. The receptacle 92 defines an opening 364 into which urine may be introduced and a second end of the receptacle 92 is in fluid communication with the urinal drain 104. The receptacle 92 is illustrated in a fully-extended or fully-opened position in FIG. 25 and occupies this position when the second member 84 is rotated away from the first member 80. When the second member 84 rotates toward the first member 80, the receptacle 92 engages the bottom of the first member 80, which causes the resilient receptacle 92 to compress or collapse under the bias applied by the first member 80. The receptacle 92 collapses until the second member 84 is rotated to a fully upward position.

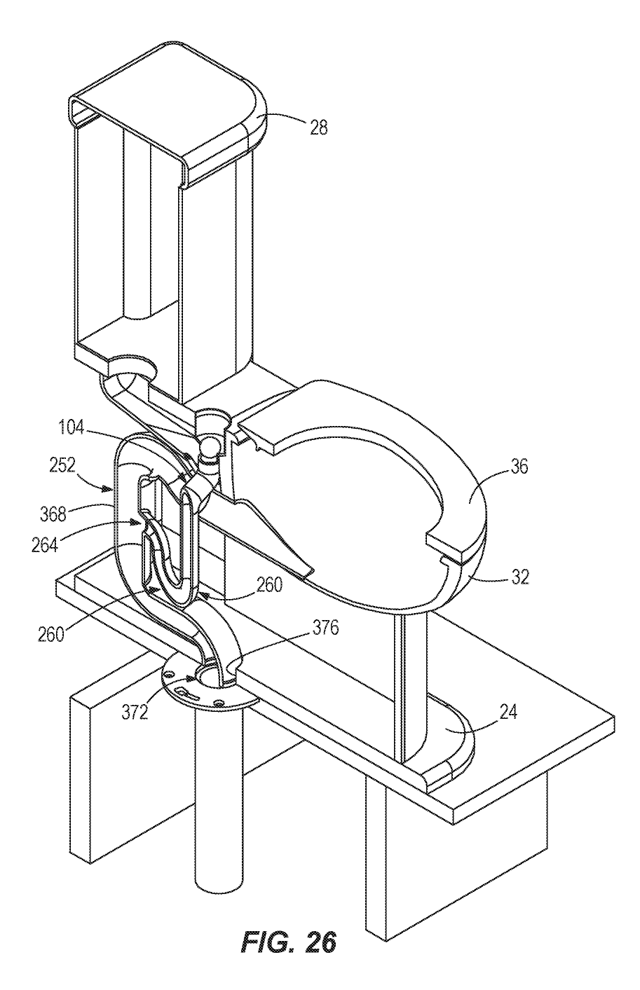

With reference to FIG. 26, another example of a drain system is illustrated. Similar components between the example of the device 20 illustrated in previous figures and the present example are represented by the same reference numbers. In this example, the device 20 includes two drains or a double drain comprised of a urinal drain 104 in fluid communication with a toilet drain 252. In this example, the urinal drain 104 is in fluid communication with the toilet drain 252 at a point further upstream than the example illustrated in previous figures. The urinal drain 104 has its own trap 260 and couples to the toilet drain 252 at a vertical portion 368 of the toilet drain 252 downstream or after the trap 268 of the toilet drain 252. The urinal drain 104 also couples to the toilet drain 252 prior to the toilet drain 252 exiting the base 24 of the device 20 and into a floor drain 372. The device 20 includes a single opening 376 in the base 24 to accommodate emptying of the toilet drain 252 into a single floor drain 372.

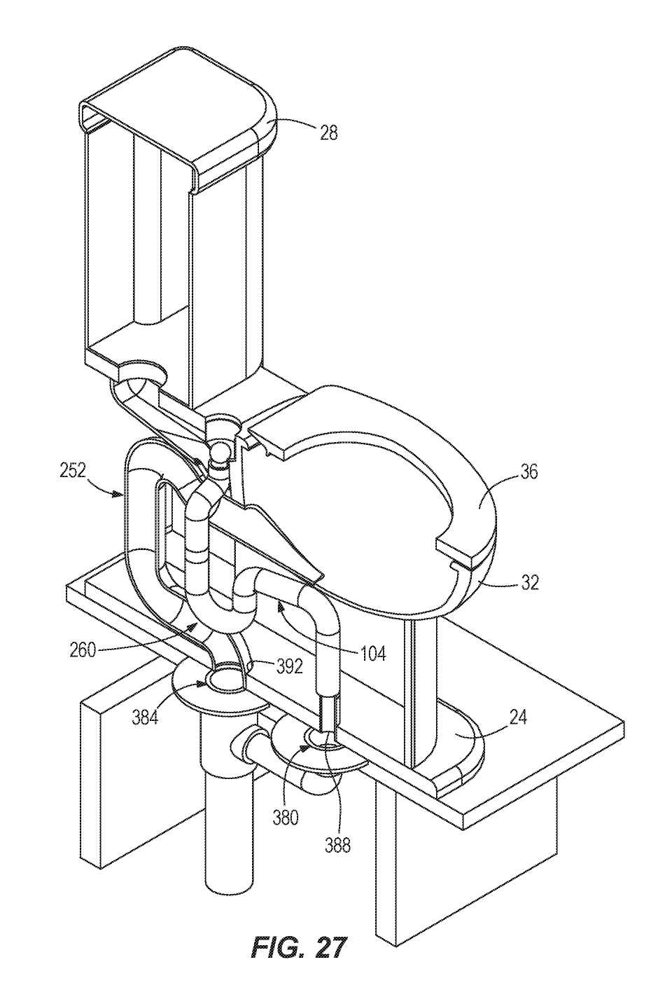

Referring now to FIG. 27, another example of a drain system is illustrated. Similar components between the example of the device 20 illustrated in previous figures and the present example are represented by the same reference numbers. In this example, the device 20 includes two drains or a double drain comprised of a urinal drain 104 and a toilet drain 252. In this example, the urinal drain 104 is not in fluid communication with the toilet drain 252. Instead, the urinal drain 104 empties into a first floor drain or pipe 380 and the toilet drain 252 empties into a second floor drain or pipe 384. The device 20 includes two openings 388, 392 in the base 24 to allow the urinal drain 104 to empty into the first floor drain 380 and the toilet drain 252 to empty into the second floor drain 384. In other words, the urinal drain 104 and the toilet drain 252 are not in fluid communication with each other within the device 20. Below the floor or downstream of the openings 388, 392 in the base 24 of the device 20, the two floor drains 380, 384 are in fluid communication. Alternatively, the two floor drains may remain separate further downstream and may not be in fluid communication with each other. Each of the urinal drain 104 and the toilet drain 252 include their own trap 260, 268.

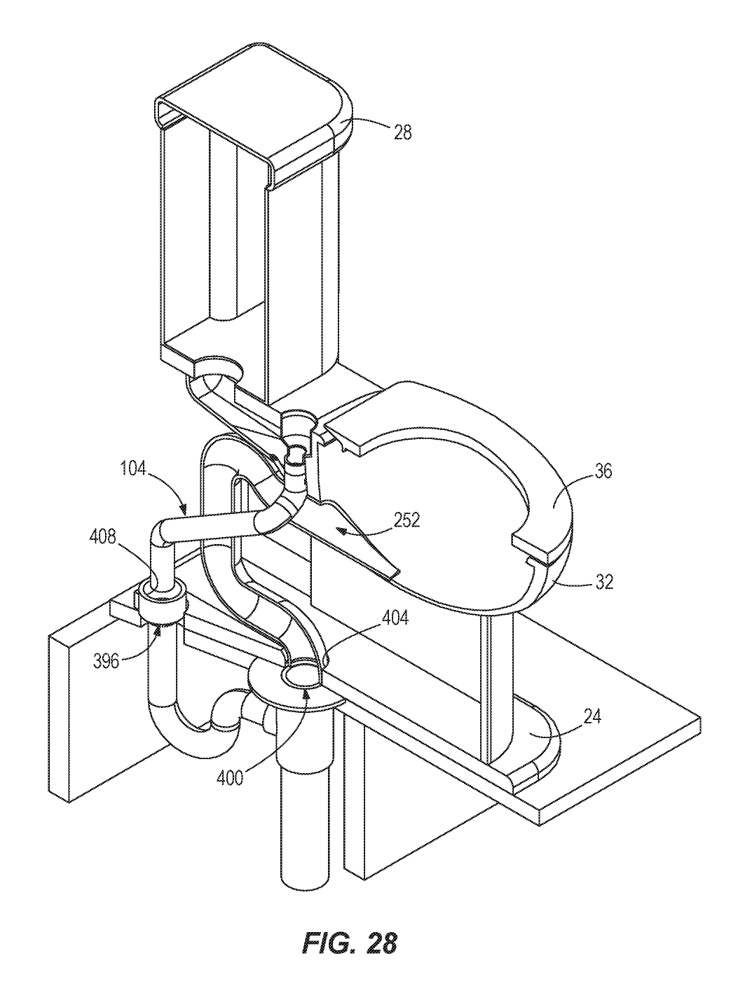

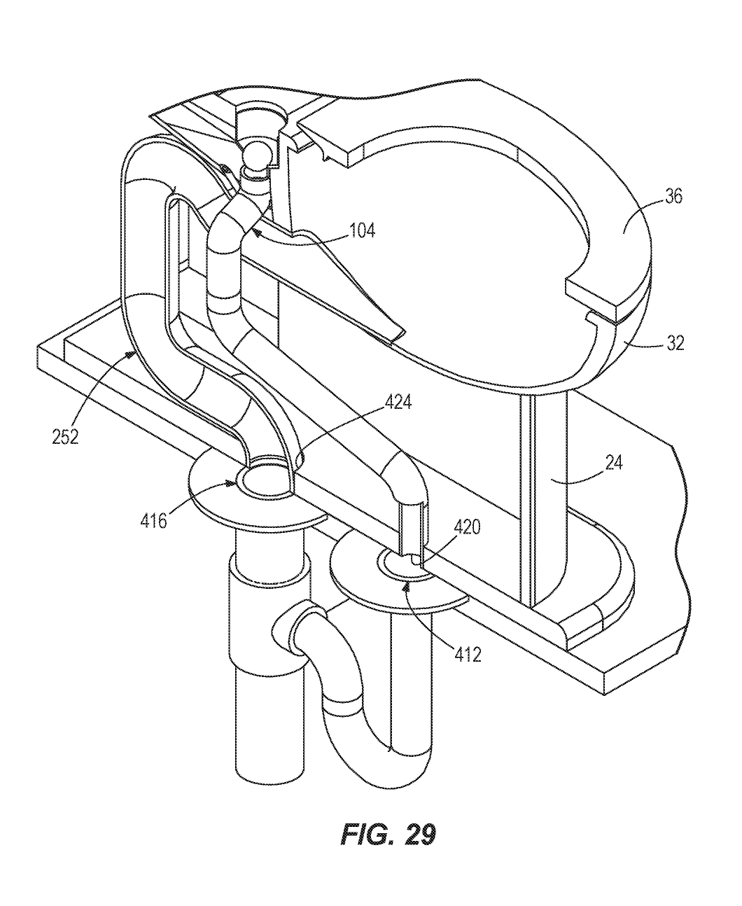

With reference to FIG. 28, another example of a drain system is illustrated. Similar components between the example of the device 20 illustrated in previous figures and the present example are represented by the same reference numbers. In this example, the device 20 includes two drains or a double drain comprised of a urinal drain 104 and a toilet drain 252. In this example, the urinal drain 104 is not in fluid communication with the toilet drain 252. Instead, the urinal drain 104 empties into a first floor drain or pipe 396 and the toilet drain 252 empties into a second floor drain or pipe 400. The device 20 includes one opening 404 in a bottom of the base 24 to allow the toilet drain 252 to empty into the second floor drain 400 and the urinal drain 104 extends out a side of the base 24 to the first floor drain 396. In other words, the urinal drain 104 and the toilet drain 252 are not in fluid communication with each other within the device 20. Below the floor or downstream of the openings in the base of the device 20, the two floor drains 396, 400 are in fluid communication. Alternatively, the two floor drains may remain separate further downstream and may not be in fluid communication with each other. In this example, the toilet drain 252 includes a toilet trap 268 within the device 20 and before the toilet drain 252 exits the device 20, and the urinal drain 104 includes a urinal trap 260 that is external and below the device 20. The urinal trap 260 is below the floor upon which the device 20 rests. Additionally, in this example, the first floor drain 396 has an open end 408 and the urinal drain 104 is positioned above and drains into the open end 408 of the first floor drain 396. In other words, the urinal drain 104 is not coupled or pipe fitted to the first floor drain 396.

Referring to FIG. 29, another example of a drain system is illustrated. Similar components between the example of the device 20 illustrated in previous figures and the present example are represented by the same reference numbers. In this example, the device 20 includes two drains or a double drain comprised of a urinal drain 104 and a toilet drain 252. In this example, the urinal drain 104 is not in fluid communication with the toilet drain 252. Instead, the urinal drain 104 empties into a first floor drain or pipe 412 and the toilet drain 252 empties into a second floor drain or pipe 416. The device 20 includes two openings 420, 424 in the base 24 to allow the urinal drain 104 to empty into the first floor drain 412 and the toilet drain 252 to empty into the second floor drain 416. In other words, the urinal drain 104 and the toilet drain 252 are not in fluid communication with each other within the device 20. Below the floor or downstream of the openings 420, 424 in the base 24 of the device 20, the two floor drains 412, 416 are in fluid communication. Alternatively, the two floor drains may remain separate further downstream and may not be in fluid communication with each other. In this example, the toilet drain 252 includes a toilet trap 268 within the device 20 and before the toilet drain 252 exits the device 20, and the urinal drain 104 includes a urinal trap 260 that is external and below the device 20. The urinal trap 260 is below the floor upon which the device 20 rests.

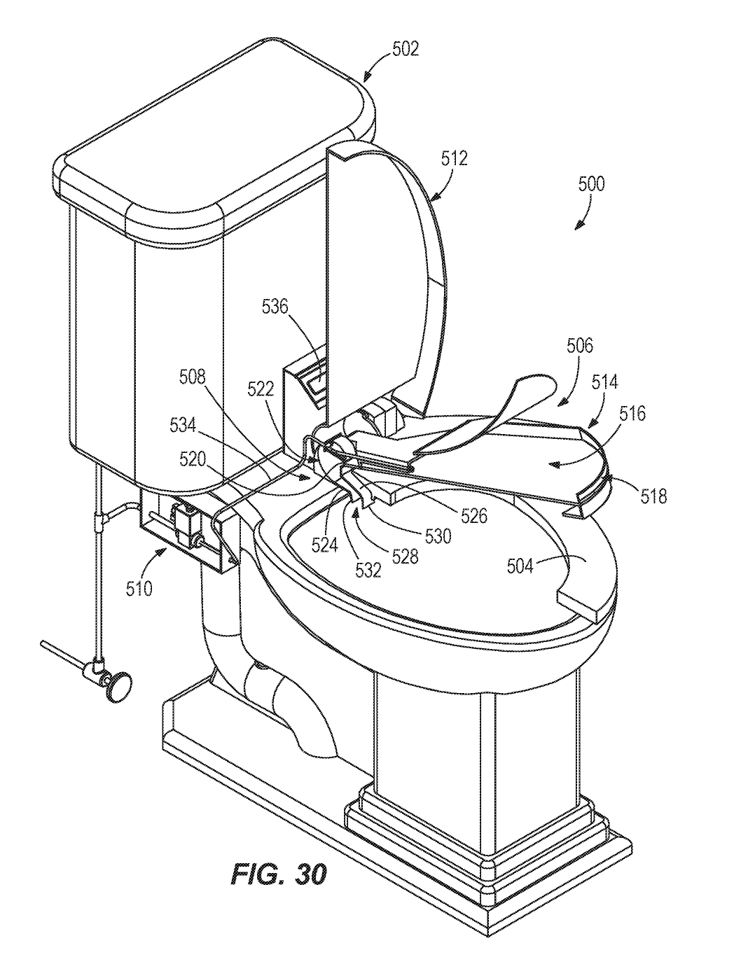

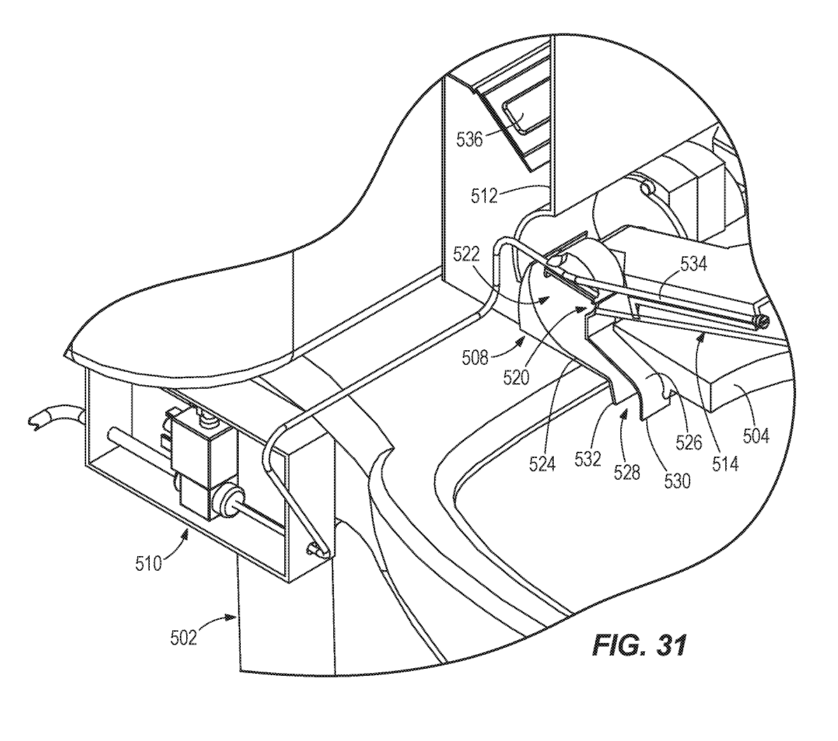

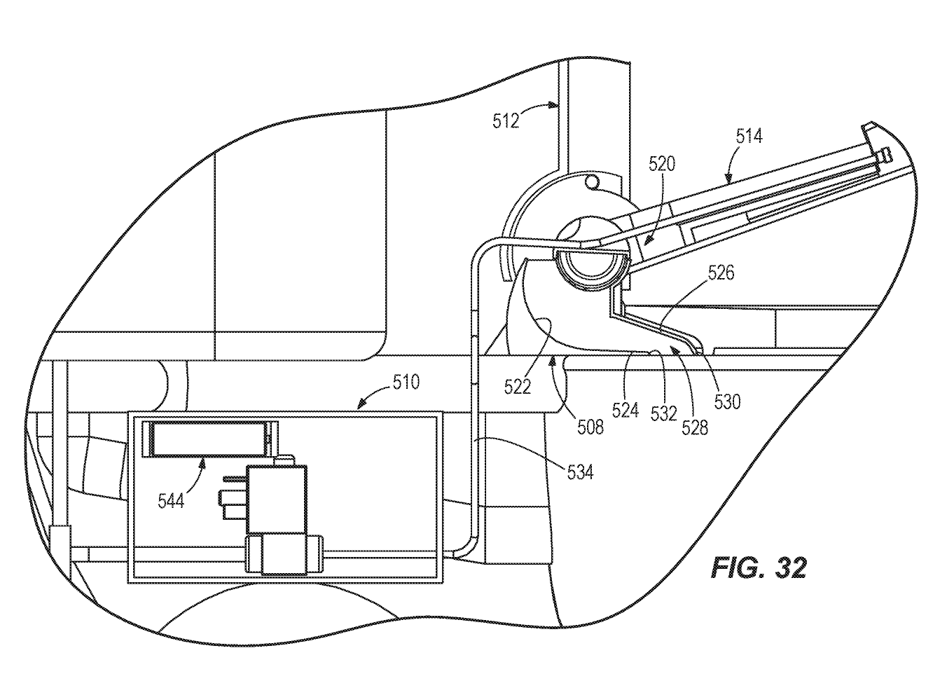

With reference to FIGS. 30-32, one example of a device 500 configured to be coupled to an existing toilet 502 to convert the toilet 502 for use as both a toilet and a urinal is illustrated. In the illustrated example, the device 500 includes a toilet seat 504, a toilet cover 506, a base 508, a component housing 510, and piping or plumbing 512. In this example, the toilet seat 36 and the first and second members 80, 84 of the toilet cover 506 rotate in similar manners to previously described examples. Rotation and movement of the toilet cover 506, the first and second members 512, 514, and the toilet seat 504 is limited and/or controlled in a similar manner as well (i.e., with cams, stop members, engagement members, etc.). In this illustrated example, the receptacle 516 has a first or open end 518 into which urine may be introduced and the receptacle 516 is shaped to funnel or divert urine toward a second end 520 distal the first end 518 of the receptacle 516. In the illustrated example, the device 500 does not include a urinal drain having piping that is in fluid communication with the toilet drain or a floor drain because the device 500 is an aftermarket device 500 added to an existing toilet 502. Accordingly, the device 500 is configured to accommodate draining of a urinal feature added to an existing toilet 502. In the illustrated example, the second end 520 of the receptacle 516 is in fluid communication with a urinal drain 522, which is in fluid communication with the toilet bowl 32. The urinal drain 522 is comprised of a bottom member 524 engaging a top surface of the toilet bowl 32 and a top member 526 spaced-apart from the bottom member 524 to provide a path and an opening 528 that opens into the toilet bowl 32. Urine may exit the urinal drain 522 through the opening 528 and fall into the toilet bowl 32. Ends 530, 532 of the top and bottom members 526, 524 are curved downward to assist with directing urine downward into the toilet bowl 32. The urine is then evacuated from the toilet bowl 32 by flushing the toilet 502 in a conventional manner.

The device 500 also includes a urinal flushing feature. In the illustrated example, the device 500 includes a solenoid 292 positioned in the component housing, a nozzle 308 for spraying into the receptacle 516, and piping 534 for fluidly coupling the nozzle 308 to the water supply. The device 500 includes an actuator 536 in communication with the solenoid 292. The actuator 536 may be actuated by a user, which then actuates the solenoid 292 to allow water to flow to the nozzle 308 where the nozzle 308 sprays the water on the inside of the receptacle 516 to clean the receptacle 516. The cleaning water then drains into the toilet bowl 32 in a similar manner to the urine described above.

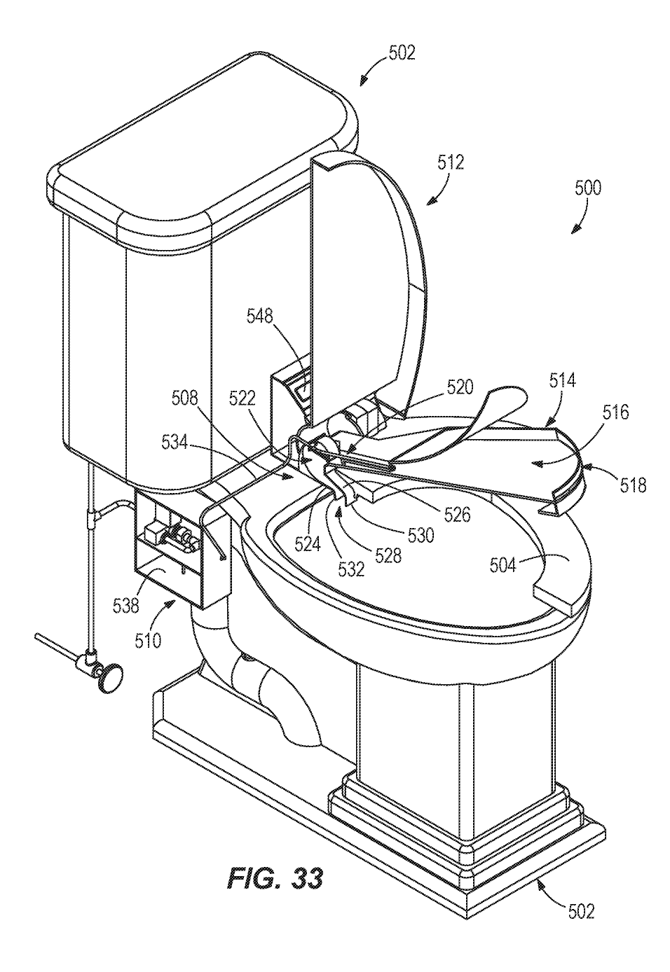

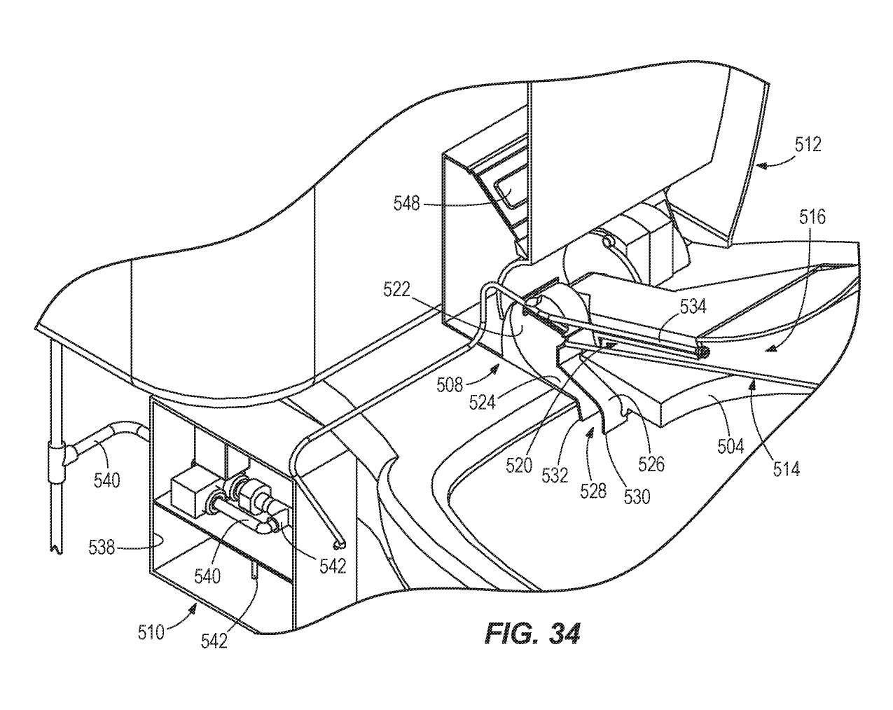

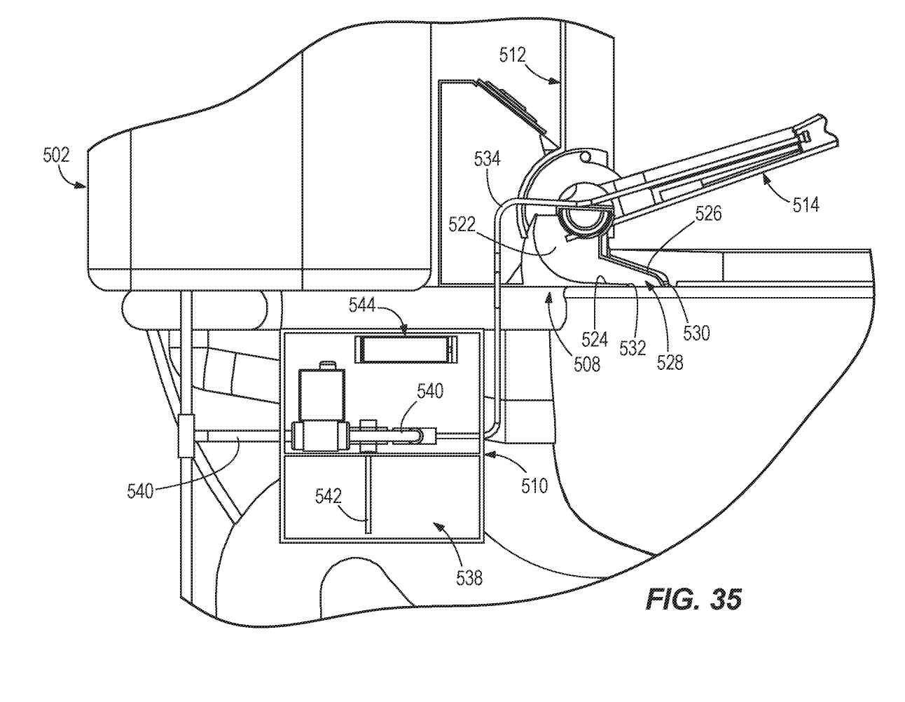

With reference to FIGS. 33-35, another example of a device 500 configured to be coupled to an existing toilet 502 to convert the toilet 502 for use as both a toilet and a urinal is illustrated. This example of the device 500 has some similarities to the example for the device 500 illustrated in FIGS. 30-32 and such similarities are identified with the same reference numbers.

In the example illustrated in FIGS. 33-35, the device 500 includes two urinal flushing features—a first flushing operation with water and a second flushing operation with a solution such as, for example, a cleaning solution or a scented solution. In this example, the device 500 includes a solenoid 292, such as, for example, a three-way solenoid 292, positioned in the component housing, an injector 296 positioned in the compartment housing 510, a solution reservoir 538 in the component housing 510, a nozzle 308 for spraying into the receptacle 516, first piping 540 for fluidly coupling the nozzle 308 to the water supply and second piping 542 for fluidly coupling the nozzle 308 to the solution reservoir 538. The device 500 also includes a power source 544 such as, for example, a battery (or other DC power source), positioned in the component housing 510. The device 500 further includes a first actuator 546 (not shown because figure in section) in communication with the solenoid 292 for allowing water from the water supply to flow to and be dispensed or sprayed by the nozzle 308, and a second actuator 548 in communication with the solenoid 292 for allowing solution from the solution reservoir 538 to flow to and be dispensed or sprayed by the nozzle 308. The first and second actuators 546, 548 may be actuated by a user as desired, which then actuates the solenoid 292 to allow either water or solution to flow to the nozzle 308 where the nozzle 308 sprays the water or solution on the inside of the receptacle 516 to clean and/or add a scent to the receptacle 516. The cleaning water and solution then drain into the toilet bowl 32 in a similar manner to the urine described above. A user may refill the solution reservoir 538 as needed and may replace the battery 544 as needed.

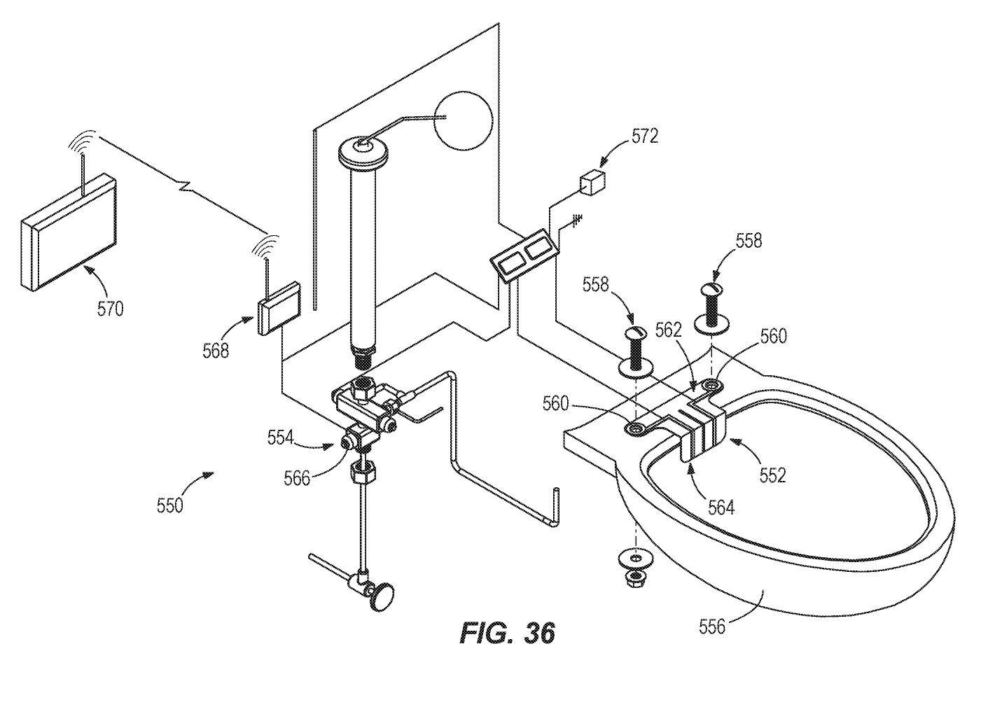

Referring now to FIG. 36, one example of an overflow assembly 550 is illustrated. The illustrated example of the overflow assembly 550 is useable with a device 500 configured to be coupled to an existing toilet 502 in order to convert the toilet 502 for use as both a toilet and a urinal is illustrated. Examples of such devices with which the overflow assembly 550 may be used are illustrated in FIGS. 30-32 and 33-35. The overflow assembly 550 is an aftermarket product that is configured to be used with or retrofitted to an existing toilet 502 in order to provide the existing toilet 502 with overflow detection capabilities.

With continued reference to FIG. 36, the illustrated example of the overflow assembly 550 includes a sensor 552 and a shut off valve 554. In the illustrated example, the sensor 552 is coupled to a toilet bowl 556 with toilet seat mounts 558 such as, for example, threaded fasteners. The sensor 552 is capable of having a wide variety of configurations and all of such possibilities are intended to be within the spirit and scope of the present disclosure. In the illustrated example, the sensor 552 is a sensor pad 552 defining two apertures 560 for receiving toilet seat mounts 558, a first portion 562 extending along a top of the toilet bowl and a second portion 564 extending downward from the first portion 562 into the toilet bowl. The second portion 564 is positioned at a level associated with an overflow condition or a condition where the toilet drain is clogged/plugged. The sensor 552 is in electrical communication with a water shut off valve 554. When the circuit is closed or the sensor 552 otherwise senses the presence of liquid at the high level, the shut off valve 554 is actuated to shut off water supply. The shut off valve 554 is positioned on the main water supply pipe to shut off the main water supply. The shut off valve 554 may include an actuator 566 that may be manually actuated to reopen the valve 554 and allow water to flow again.

With continued reference to FIG. 36, the overflow assembly 550 may also include a first communication device 568 in electrical communication with the sensor 552. The first communication device 568 is configured to communicate a signal to a second communication device 570. The second communication device 570 is configured to perform one or more functions based on the information or data received from the first communication device 568. In one example, the first communication device 568 is hardwired with the second communication device 570 and information or data is transmitted between the first communication device 568 and the second communication device 570 over one or more wires. In the illustrated example, the first communication device 568 and the second communication device 570 each include at least one network interface and communicate with each other wirelessly over one or more networks via the network interfaces. Examples of networks over which the first and second communication devices 568, 570 communicate include, but are not limited to a cellular network, Wi-Fi, the Internet, a local area network (LAN), a wide area network (WAN), or any other type of network. The first and second communication devices 568, 570 include network interfaces complementary to the one or more networks over which communication occurs.

The second communication device 570 is configured to perform a wide variety of functions including, but not limited to, one or more of providing an audible noise or alarm (for example, a speaker or other audio device emitting a sound), providing a visual indicator or alarm (for example, illuminating one or more lights, displaying visual indicia on a display or monitor), transmitting information or data back to the first communication device 568 over the one or more networks to instruct one or more components of the overflow assembly 550 to perform a function, transmitting information or data to a 3rd party communication device where a 3rd party may be notified of the information or data transmitted from the sensor 552 and the first communication device 568 (for example, a maintenance entity, plumbing entity, corporate headquarters, etc.). For example, the second communication device 570 may communicate information or data over the one or more networks to instruct the overflow shut off valve 554 to shut off the water supply. The overflow assembly 550 may either be electrically connected to an AC power source such as, for example, a wall electrical outlet or hardwired to an AC power source, or may include its own power source such as, for example, a DC power source 572 (for example, a battery). If an AC power source is utilized, the overflow assembly may include an AC/DC converter. The second communication device 570 may also communicate information or data over the one or more networks to the first communication device 568, which then may communicate information or data to the overflow shut off valve 554 such as, for example, to reopen after it has been closed.

With continued reference to FIG. 36, the assembly 550 also includes a second sensor 551 positioned in the reservoir tank. The second sensor 551 is positioned in the reservoir tank to identify a leak in the reservoir tank. In some instances, the reservoir tank may have a slow or rapid leak that may result in liquid exiting the toilet and flowing into/onto the wall and/or the floor. Additionally, a water leak in the reservoir tank may result in the reservoir tank containing insufficient water to facilitate flushing of the toilet. The reservoir tank may leak for a variety of reasons. The second sensor 551 is configured to include similar structure and functionality to the second sensor 341 described above and illustrated in FIG. 23. Thus, for the sake of brevity, the structure and functionality of the second sensor 551 will not be described again herein.

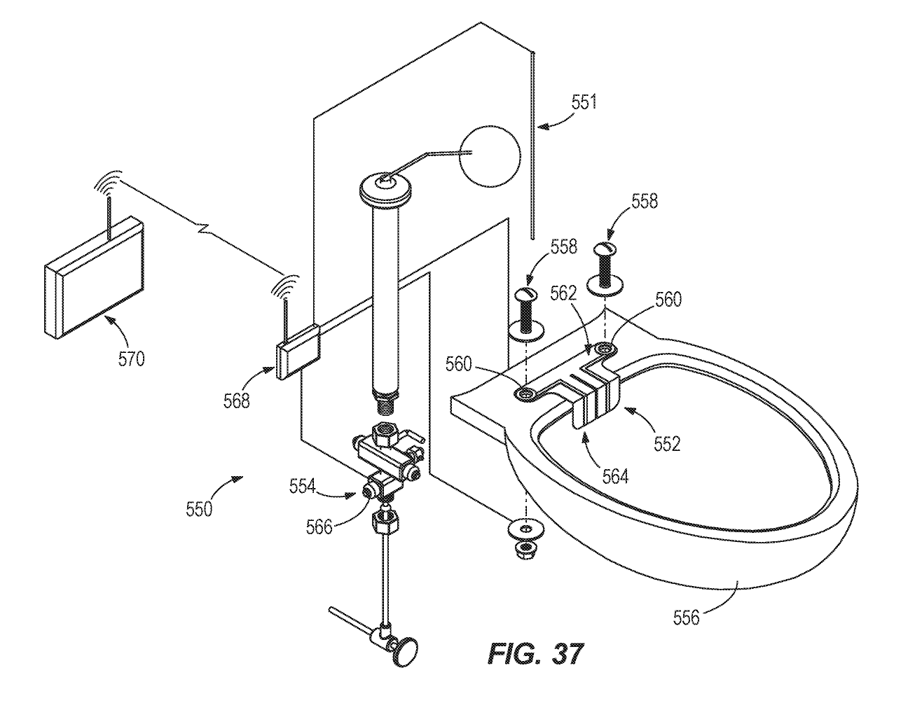

Referring now to FIG. 37, another example of an overflow assembly 550 is illustrated. The illustrated example of the overflow assembly 550 is an aftermarket product that is configured to be used with or retrofitted to an existing toilet 502 in order to provide the existing toilet 502 with overflow detection capabilities. This example of the overflow assembly 550 is not used with a device 500 and is instead used with an existing toilet 502. The overflow assembly 550 illustrated in FIG. 37 includes many similarities to the overflow assembly 550 illustrated in FIG. 36, and all of the structure and function described above with respect to the overflow assembly 550 illustrated in FIG. 36 are intended to be included in the overflow assembly 550 illustrated in FIG. 37 except for the structure and function associated with the device 500 and/or the urinal capability illustrated and described with respect to FIG. 36.

With continued reference to FIG. 37, the assembly 550 also includes a second sensor 551 positioned in the reservoir tank. The second sensor 551 is configured to include similar structure and functionality to the second sensor 341 described above and illustrated in FIG. 23. Thus, for the sake of brevity, the structure and functionality of the second sensor 551 will not be described again herein.

The devices disclosed herein are configured to include a wide variety of components, some of which facilitate communication between various components and control of the devices. For example, the devices may include a control member, controller, processor, etc. The control member may communicates with the various components of the devices to retrieve and/or send information or data as necessary. The control member may include any necessary hardware, software or any combination thereof to achieve the processes, methods, functionalities, operations, etc., of the present disclosure.

In one example, the control member may be comprised of one or more of software and/or hardware in any proportion. In such an example, the control member may reside on a computer-based platform such as, for example, a server or set of servers. Any such server or servers may be a physical server(s) or a virtual machine(s) executing on another hardware platform or platforms. The nature of the configuration of such server or servers is not critical to the present disclosure. Any server, or for that matter any computer-based system, systems or elements described herein, will be generally characterized by one or more processors and associated processing elements and storage devices communicatively interconnected to one another by one or more busses or other communication mechanism for communicating information or data. In one example, storage within such devices may include a main memory such as, for example, a random access memory (RAM) or other dynamic storage devices, for storing information and instructions to be executed by the processor(s) and for storing temporary variables or other intermediate information during the use of the control member described herein. In one example, the control member may also include a static storage device such as, for example, read only memory (ROM), for storing static information and instructions for the processor(s). In one example, the control member may include a storage device such as, for example, a hard disk or solid state memory, for storing information and instructions. Such storing information and instructions may include, but not be limited to, instructions to compute, which may include, but not be limited to processing and analyzing information of all types. RAMs, ROMs, hard disks, solid state memories, and the like, are all examples of tangible computer readable media, which may be used to store instructions which comprise processes, methods and functionalities of the present disclosure. Execution of such instructions by the control member may cause the various computer-based elements of the control member to perform the processes, methods, functionalities, operations, etc., described herein. In some examples, the control member of the present disclosure may include hard-wired circuitry to be used in place of or in combination with, in any proportion, such computer-readable instructions to implement the disclosure.

It should be understood that the use of any orientation or directional terms herein such as, for example, “top”, “bottom”, “front”, “rear”, “back”, “left”, “right”, “side”, etc., is not intended to imply only a single orientation of the item with which it is associated or to limit the present disclosure in any manner. The use of such orientation or directional terms is intended to assist with the understanding of principles disclosed herein and to correspond to the exemplary orientation illustrated in the drawings. For example, the devices and any components thereof may be utilized in any orientation and use of such terms is intended to correspond to the exemplary orientation of the devices and their components illustrated in the drawings. The use of these terms in association with the devices and their components are not intended to limit the devices or their components to a single orientation or to limit the devices and their components in any manner.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments of the disclosure have been described, it will be apparent to those of ordinary skill in the art that other embodiments and implementations are possible within the scope of the disclosure. Accordingly, the disclosure is not to be restricted except in light of the attached claims and their equivalents.

1. A device including urinal and toilet capabilities, the device comprising:
a toilet bowl;
a toilet seat coupled to and rotatable relative to the toilet bowl; and
a toilet cover coupled to and rotatable relative to the toilet bowl, wherein the toilet cover includes a receptacle configured to receive urine.

2. The device of claim 1, wherein the toilet cover includes a first member and a second member rotatable relative to the first member, wherein the receptacle is positioned between the first member and the second member, and wherein the receptacle is configured to be in fluid communication with a drain.

3. The device of claim 2, wherein the receptacle has a closed position, in which the first member and the second member are proximate each other, and an opened position, in which the second member is rotated away from the first member.

4. The device of claim 3, wherein the second member includes a resilient wall at least partially defining the receptacle and is at least partially resiliently biased away from the second member due to its resiliency, wherein the resilient wall is biased toward the second member in the closed position and moves away from the second member in the opened position.

5. The device of claim 3, further comprising an engagement member configured to engage the first member and inhibit downward rotation of the first member toward the toilet bowl with the receptacle in the opened position.

6. The device of claim 5, wherein the engagement member does not inhibit downward rotation of the first member toward the toilet bowl with the receptacle in the closed position.

7. The device of claim 3, further comprising an engagement member configured to engage the first member and the second member, wherein the second member is configured to move the engagement member between a locked condition, in which the engagement member inhibits the first member from moving and allows the second member to move relative to the first member to present the receptacle in the opened position, and an unlocked condition, in which the second member is rotated proximate the first member, the receptacle is in the closed position and the first and second members are configured to rotate together toward the toilet bowl.

8. The device of claim 7, wherein the engagement member is resilient and is resiliently biased toward the locked condition.

9. The device of claim 1, wherein the receptacle is in fluid communication with a first drain and the toilet bowl is in fluid communication with a second drain separate from the first drain.

10. The device of claim 9, wherein the first drain includes a first trap and the second drain includes a second trap.

11. The device of claim 1, further comprising a nozzle configured to spray liquid into the receptacle.

12. The device of claim 11, wherein the nozzle is in fluid communication with a water supply and is configured to spray water into the receptacle.

13. The device of claim 11, wherein the nozzle is in fluid communication with a source of sanitizing solution and is configured to spray sanitizing solution into the receptacle.

14. The device of claim 13, wherein the nozzle is also in fluid communication with a water supply, and wherein the nozzle is configured to selectively spray at least one of water and sanitizing solution into the receptacle.

15. The device of claim 1, further comprising an overflow sensor configured to sense an overflow condition in the toilet bowl.

16-43. (canceled)
